(19) United States
(12) Patent Application Publication
(10) Pub. No.: US 2026/0141864 A1
(43) Pub. Date: May 21, 2026

(54) DISPLAY APPARATUS AND DISPLAY PANEL

(71) Applicant: LG Display Co., Ltd., Seoul (KR)

(72) Inventors: Jun-Ho BONG, Paju-si (KR); Min-Woo PARK, Paju-si (KR)

(21) Appl. No.: 19/346,174

(22) Filed: Sep. 30, 2025

(30) Foreign Application Priority Data
Nov. 19, 2024 (KR) 10-2024-0165095

(51) Int. Cl. G09G 3/3266

(52) U.S. Cl. CPC G09G 3/3266; G09G 2310/0245; G09G 2310/08; G09G 2330/021

(57) ABSTRACT

A display apparatus includes a first scan stage applying a first scan signal, wherein the first scan stage includes: first and second control transistors which are connected in parallel to each other, is configured to receive a carry signal, and is connected to a Q2 node; and third and fourth control transistors which are connected in series to each other with a QB node therebetween, and have respective gate electrodes connected to the Q2 node, wherein in the first scan stage that is configured to output the first scan signal of a n-th horizontal line, the pull-up transistor is configured to receive a second B scan clock, a gate electrode of the first control transistor is configured to receive a first B scan clock, and a gate electrode of the second control transistor is configured to receive a first scan clock or the second B scan clock.

### CROSS REFERENCE TO RELATED APPLICATIONS

Pursuant to 35 U.S.C. § 119(a), this application claims the benefit of an earlier filing date and right of priority to Korean Patent Application No. 10-2024-0165095 filed in Republic of Korea on Nov. 19, 2024, the entire contents of which are hereby expressly incorporated by reference into the present application.

### TECHNICAL FIELD

The present disclosure relates to a display apparatus and a display panel.

### BACKGROUND

As the information society develops, demands for display apparatuses for displaying images have increased in various forms, and in recent years, various flat display apparatuses such as organic light emitting display apparatuses and liquid crystal display apparatuses have been used.

In an example, a gate driving circuit of the organic light emitting display apparatus includes a separate inverter circuit configured using an CMOS to generate a scan signal. The inverter circuit inverts an input signal to output the scan signal.

### SUMMARY

According to a first aspect, a display apparatus includes a first scan stage applying a first scan signal, wherein the first scan stage includes: first and second control transistors which are connected in parallel to each other, is configured to receive a carry signal, and is connected to a Q2 node; and third and fourth control transistors which are connected in series to each other with a QB node therebetween, and have respective gate electrodes connected to the Q2 node, wherein in the first scan stage that is configured to output the first scan signal of a n-th horizontal line, the pull-up transistor is configured to receive a second B scan clock, a gate electrode of the first control transistor is configured to receive a first B scan clock, and a gate electrode of the second control transistor is configured to receive a first scan clock or the second B scan clock.

### BRIEF DESCRIPTION OF THE DRAWINGS

The accompanying drawings, which are included to provide a further understanding of the disclosure and are incorporated in and constitute a part of this specification, illustrate implementations of the disclosure and together with the description serve to explain the principles of the disclosure.

FIG. 1 is a view schematically illustrating a display apparatus according to a first exemplary implementation of the present disclosure;

FIG. 2 is a circuit view schematically illustrating an example of a pixel according to a first exemplary implementation of the present disclosure;

FIG. 3 is a view illustrating a configuration of a gate driving portion of a display apparatus according to a first exemplary implementation of the present disclosure;

FIGS. 4 and 5 are timing charts schematically illustrating an example of driving signals output from a gate driving portion according to a first exemplary implementation of the present disclosure;

FIG. 6 is a cross-sectional view schematically illustrating an example of a cross-sectional structure of a display panel according to a first exemplary implementation of the present disclosure;

FIG. 7 is a view schematically illustrating an example of a structure of a scan driving circuit according to a first exemplary implementation of the present disclosure;

FIG. 8 is a waveform view schematically illustrating timings of signals driving a scan driving circuit of FIG. 7;

FIG. 9 is a view schematically illustrating an example of a structure of a scan driving circuit according to a second exemplary implementation of the present disclosure;

FIG. 10 is a view schematically illustrating an example of a structure of a scan driving circuit according to a third implementation of the present disclosure; and

FIG. 11 is a waveform view schematically illustrating timings of signals driving a scan driving circuit of FIG. 10.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

Including an inverter circuit within a gate driving circuit of a display device can increase a size of the gate driving circuit. This can increase a bezel of the display apparatus and make it difficult to achieve a narrow bezel.

Implementations of the present disclosure can provide a display apparatus that can reduce a size of a gate driving circuit and implement a narrow bezel of the display apparatus.

It is to be understood that both the foregoing general description and the following detailed description are exemplary and explanatory and are intended to provide further explanation of the disclosure as claimed.

Additional features and advantages of the disclosure will be set forth in the description which follows, and in part will be apparent from the description, or learned by practice of the disclosure. These and other advantages of the disclosure will be realized and attained by the structure particularly pointed out in the written description and claims hereof as well as the appended drawings.

Reference will now be made in detail to implementations of the present disclosure, examples of which may be illustrated in the accompanying drawings. The progression of processing steps and/or operations described is an example; however, the sequence of steps and/or operations is not limited to that set forth herein and can be changed as is known in the art, with the exception of steps and/or operations necessarily occurring in a particular order. Names of the respective elements used in the following explanations are illustrative and can be thus different from those used in actual products.

Advantages and features of the present disclosure and methods of achieving them will be apparent with reference to the implementations described below in detail with the accompanying drawings. However, the present disclosure is not limited to the implementations disclosed below, but can be realized in a variety of different forms. These example aspects are provided so that the present disclosure will be sufficiently thorough and complete so as to assist those skilled in the art to fully understand the scope of the present disclosure.

The shapes (e.g., sizes, lengths, widths, heights, thicknesses, locations, radii, diameters, and areas), proportions, angles, numbers, and the like disclosed in the drawings for explaining the implementations of the present disclosure are illustrative, and the present disclosure is not limited to the illustrated matters. The same reference numerals refer to the same components throughout the description.

Furthermore, in describing the present disclosure, if it is determined that a detailed description of the related known technology unnecessarily obscure the subject matter of the present disclosure, the detailed description thereof can be omitted. When ‘comprising’, ‘including’, ‘having’, ‘consisting’, and the like are used in this disclosure, other parts can be added unless ‘only’ is used. When a component is expressed in the singular, cases including the plural are included unless specific statement is described.

The word “exemplary” is used to mean serving as an example or illustration. Aspects are example aspects. “Implementations,” “examples,” “aspects,” and the like should not be construed as preferred or advantageous over other implementations. An implementation, an example, an example implementation, an aspect, or the like can refer to one or more implementations, one or more examples, one or more example implementations, one or more aspects, or the like, unless stated otherwise. Further, the term “may” encompasses all the meanings of the term “can.”

In interpreting the components, even if there is no separate explicit description, it is interpreted as including a margin range. Any implementation described herein as an “example” is not necessarily to be construed as preferred or advantageous over other implementations.

In the case of a description of a positional relationship, for example, when the positional relationship of two parts is described as ‘on’, ‘over’, ‘above’, ‘below’, ‘beside’, ‘under’, and the like, one or more other parts can be positioned between such two parts unless ‘right’ or ‘directly’ is used.

In the case of a description of a temporal relationship, for example, when a temporal precedence is described as ‘after’, ‘following’, ‘before’, and the like, cases that are not continuous can be included unless ‘directly’ or ‘immediately’ is used.

The terms, such as “below,” “lower,” “above,” “upper” and the like, can be used herein to describe a relationship between element(s) as illustrated in the drawings. It will be understood that the terms are spatially relative and based on the orientation depicted in the drawings.

In describing components of the present disclosure, terms such as first, second “A,” “B,” “(a),” and “(b)” and the like can be used. These terms are only for distinguishing the components from other components, and an essence, order, order, or number of the components is not limited by the terms.

Respective features of various implementations of the present disclosure can be partially or wholly connected to or combined with each other and can be technically interlocked and driven variously, and respective implementations can be independently implemented from each other or can be implemented together with a related relationship.

The term “at least one” should be understood as including any and all combinations of one or more of the associated listed items. For example, the meaning of “at least one of a first element, a second element, and a third element” compasses the combination of all three listed elements, combinations of any two of the three elements, as well as each individual element, the first element, the second element, or the third element.

Unless otherwise defined, all terms (including technical and scientific terms) used herein have the same meaning as commonly understood by one of ordinary skill in the art to which example implementations belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” can apply, for example, to a separate circuit or structure, an integrated circuit, a computational block of a circuit device, or any structure configured to perform a described function as should be understood to one of ordinary skill in the art.

Hereinafter, exemplary implementations of the present disclosure are described in detail with reference to the drawings. Meanwhile, in the following exemplary implementations, the same and like reference numerals are assigned to the same and like components, and detailed descriptions thereof can be omitted or briefly given.

### First Implementation:

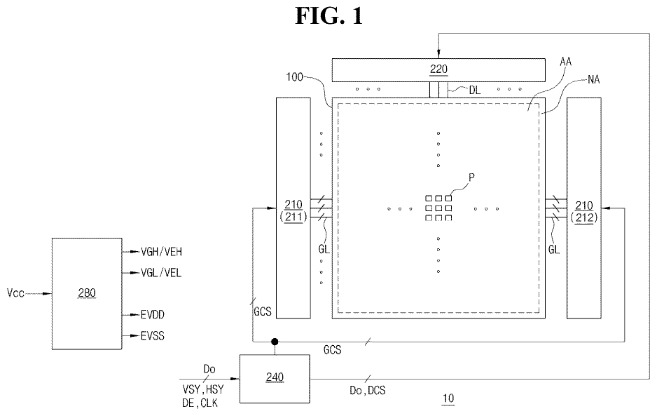

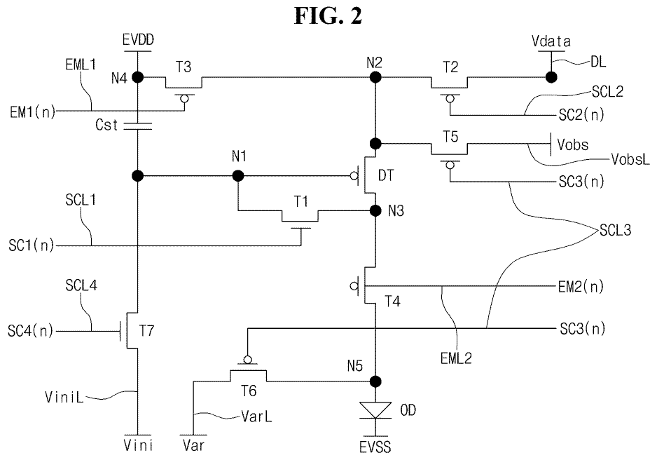

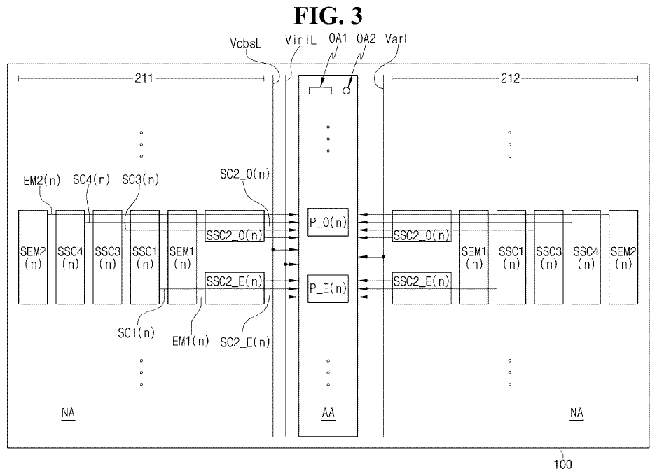

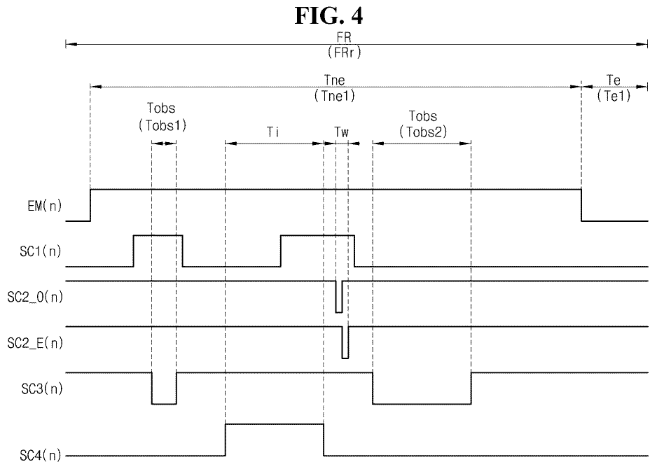

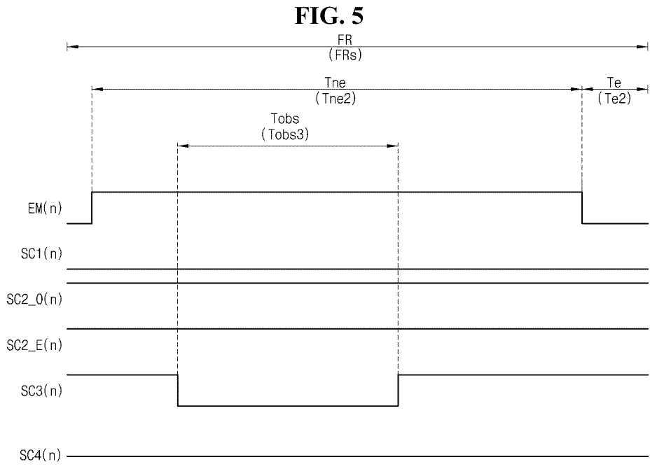

FIG. 1 is a view schematically illustrating a display apparatus according to a first exemplary implementation of the present disclosure. FIG. 2 is a circuit view schematically illustrating an example of a pixel according to a first exemplary implementation of the present disclosure. FIG. 3 is a view illustrating a configuration of a gate driving portion of a display apparatus according to a first exemplary implementation of the present disclosure. FIGS. 4 and 5 are timing charts schematically illustrating an example of driving signals output from a gate driving portion according to a first exemplary implementation of the present disclosure. FIG. 4 illustrates driving signals output during a refresh frame in a VRR method of a first exemplary implementation of the present disclosure, and FIG. 5 illustrates driving signals output during a skip frame in a VRR method of a first exemplary implementation of the present disclosure.

Prior to a specific description, the display apparatus 10 according to this exemplary implementation can include a light emitting display apparatus equipped with a light emitting diode. Furthermore, the display apparatus 10 of this exemplary implementation can include all types of display apparatuses to which a VRR (variable refresh rate) method is applied.

Meanwhile, for convenience of explanation, in this exemplary implementation, an organic light emitting display apparatus is described as an example of the display apparatus 10.

Referring to FIGS. 1 to 5, the display apparatus 10 of this exemplary implementation can include a display panel 100 and a driving circuit portion that drives the display panel 100.

Here, the driving circuit portion can include, for example, a gate driving portion (or gate driving circuit) 210, a data driving portion (or data driving circuit) 220, and a timing control portion (or timing control circuit) 240. In addition, the driving circuit portion can include a power supply portion (or power supply circuit) 280 that supplies power required for driving the display panel 100, the gate driving portion 210, the data driving portion 220, and the timing control portion 240.

The display panel 100 can include a display region AA that displays an image, and a non-display region NA arranged outside the display region AA (or fully or partially surrounding the display region AA). As an example, the non-display region NA can be partially or fully invisible from a front side of the display panel 100, for example, by being bent toward a rear side of the display panel 100, without being limited thereto. As an example, the entire non-display region NA can be flat.

In the display region AA, a plurality of pixels P can be arranged in a matrix form along a plurality of horizontal lines (or row lines) and a plurality of vertical lines (or column lines).

Here, the plurality of pixels P can include pixels that display different colors, for example, red, green, and blue pixels that display red, green, and blue, respectively, but not limited thereto. As an example, the plurality of pixels P can include white pixels that display white. As another example, the plurality of pixels P can additionally or alternatively include pixels that display colors other than red, green, blue, white, such as cyan, magenta, or yellow, etc., without being limited thereto.

In the display panel 100, various signal lines that transmit driving signals for driving the pixels P can be formed on a substrate.

In this regard, for example, a plurality of data lines DL that transmit data signals (or data voltages) which are image signals can extend in the vertical direction and be connected to the pixels P of the respective vertical lines.

In addition, a gate line GL that transmits a gate signal (or gate voltage) can extend in the horizontal direction and be connected to the pixel P of the corresponding horizontal line.

In this exemplary implementation, a plurality of gate signals can be used to drive each pixel P, for example, a first scan signal SC1 to a fourth scan signal SC4 and an emission control signal EM can be used. Accordingly, a plurality of gate lines GL respectively transmitting the plurality of gate signals can be used, for example, a first scan line SCL1 to a fourth scan line SCL4 and an emission control line EML can be used. Implementations are not limited thereto. As an example, each pixel P can be driven by one or more gate signals. As an example, at least one of the first scan signal SC1 to the fourth scan signal SC4 and the emission control signal EM can be omitted, depending on the design.

As such, the plurality of pixels P can be defined by the plurality of data lines DL and gate lines GL intersecting each other.

Each pixel P can include a light emitting diode OD as a light emitting element, and a plurality of transistors and at least one capacitor for driving the light emitting diode OD.

Meanwhile, in this exemplary implementation, for convenience of explanation, an 8T1C structure in which the pixel P is equipped with eight transistors T1 to T7 and DT and one capacitor Cst as illustrated in FIG. 2 is taken as an example. Implementations are not limited thereto. As an example, each pixel P can include one or more transistors and one or more capacitor. As an example, each pixel P can have a 2T1C structure, a 3T2C structure, a 5T2C structure, etc., without being limited thereto.

Referring to FIG. 2, the pixel P can include a plurality of switching transistors, for example, first transistor T1 to seventh transistor T7, a driving transistor DT, a storage capacitor Cst, and the light emitting diode OD.

Each of the first to seventh transistors T1 to T7 and the driving transistor DT can include a first electrode, a second electrode, and a gate electrode. One of the first electrode and the second electrode can be a source electrode, and the other of the first electrode and the second electrode can be a drain electrode.

Each of the first to seventh transistors T1 to T7 and the driving transistor DT can be a P-type or N-type transistor. Meanwhile, in FIG. 2, as an example, the second, third, fourth, fifth, and sixth transistors T2, T3, T4, T5, and T6 are configured as P-type transistors, the first and seventh transistors T1 and T7 are configured as N-type transistors, and the driving transistor DT is configured as a P-type transistor, but not limited thereto. Alternatively, the driving transistor DT can be configured as an N-type transistor.

The first transistor T1 to the seventh transistor T7 and the driving transistor DT can include semiconductors of the same material or can include semiconductors of different materials. In this regard, for example, some of the first transistor T1 to the seventh transistor T7 and the driving transistors DT can have one semiconductor layer among a polycrystalline silicon layer, an oxide semiconductor layer, an amorphous silicon layer, a compound semiconductor layer, and an oxide semiconductor layer, and another some of the first transistor T1 to the seventh transistor T7 and the driving transistors DT can have another semiconductor layer among a polycrystalline silicon layer, an oxide semiconductor layer, an amorphous silicon layer a compound semiconductor layer, and an oxide semiconductor layer, without being limited thereto.

Meanwhile, since an oxide semiconductor has excellent off-current characteristics and has characteristics suitable for a switching transistor, at least one of the first transistor T1 to the seventh transistor T7 can have an oxide semiconductor layer. In addition, since a polycrystalline silicon has excellent mobility, the driving transistor DT can have a polycrystalline silicon layer. Of course, the first transistor T1 to the seventh transistor T7 and the driving transistor DT can be configured in another form. For example, the driving transistor DT can have an oxide semiconductor layer.

Meanwhile, in this exemplary implementation, a case where the first and seventh transistors T1 and T7 include oxide semiconductor layers and the remaining transistors T2 to T6 and DT include polycrystalline silicon layers is taken as an example.

The gate signals provided to a n-th horizontal line of FIG. 2 (more specifically, at least one of an odd horizontal line and an even horizontal line constituting the n-th horizontal line) can be provided from a corresponding n-th stage of the gate driving portion 210. For example, four scan signals, first to fourth scan signals (SC1 to SC4: SC1(n) to SC4(n) ) and two emission control signals, first and second emission control signals (EM: EM1(n) and EM2(n) ) can be provided. In this case, in the display region AA, first to fourth scan lines SCL1 to SCL4 and first and second emission control lines EML1 and EML2 that are connected to the n-th stage and transmit the first to fourth scan signals SC1(n) to SC4(n) and the first and second emission control signals EM1(n) and EM2(n) to the pixel P can be arranged. Alternatively, the gate driving portion 210 can be configured to provide one emission control signal instead of the two emission control signals EM1(n) and EM2(n).

The first transistor T1 can function as a sampling transistor, the second transistor T2 can function as a data supply transistor, the third and fourth transistors T3 and T4 can function as emission control transistors, the fifth transistor T5 can function as a bias transistor, the sixth transistor T6 can function as a reset transistor (or a first initialization transistor), and the seventh transistor T7 can function as an initialization transistor (or a second initialization transistor).

The light emitting diode OD can include an anode electrode and a cathode electrode. The anode electrode of the light emitting diode OD can be connected to a fifth node N5, and the cathode electrode of the light emitting diode OD can be applied with a low-potential driving voltage EVSS.

The driving transistor DT can include a first electrode connected to a second node N2, a second electrode connected to a third node N3, and a gate electrode connected to a first node N1. The driving transistor DT can provide a driving current to the light emitting diode OD based on a voltage of the first node N1 (i.e., the data voltage Vdata stored in the storage capacitor Cst).

The first transistor T1 can include a first electrode connected to the first node N1, a second electrode connected to the third node N3, and a gate electrode receiving the first scan signal SC1(n) . The first transistor T1 can be turned on in response to the first scan signal SC1(n) , and the data voltage Vdata can be applied (or written or sampled) to the gate electrode of the driving transistor DT.

The storage capacitor Cst can be connected between the first node N1 and a fourth node N4. The storage capacitor Cst can store or maintain a high-potential driving voltage EVDD.

The second transistor T2 can include a first electrode connected to the data line DL (or, receiving the data voltage Vdata), a second electrode connected to the second node N2, and a gate electrode receiving the second scan signal SC2(n) . The second transistor T2 can be turned on in response to the second scan signal SC2(n) and transmit the data voltage Vdata to the second node N2.

The third transistor T3 and the fourth transistor T4 (or first and second emission control transistors) can be connected between a power line of the high-potential driving voltage EVDD and the light emitting diode OD, and can form a current path along which the driving current generated by the driving transistor DT moves.

The third transistor T3 can include a first electrode connected to the fourth node N4 and receiving the high-potential driving voltage EVDD, a second electrode connected to the second node N2, and a gate electrode receiving the first emission control signal EM1(n) .

The fourth transistor T4 can include a first electrode connected to the third node N3, a second electrode connected to the fifth node N5 (or the anode electrode of the light emitting diode OD), and a gate electrode receiving the second emission control signal EM2(n) .

The third and fourth transistors T3 and T4 can be turned on in response to the first and second emission control signals EM1(n) and EM2(n) , and the driving current can be supplied to the light emitting diode OD, and the light emitting diode OD can emit light with a luminance corresponding to the driving current.

The fifth transistor T5 can include a first electrode connected to a bias voltage line VobsL that transmits a bias voltage Vobs, a second electrode connected to the second node N2, and a gate electrode that receives the third scan signal SC3(n) .

The sixth transistor T6 can include a first electrode connected to a reset voltage line (or a first initialization voltage line) VarL that transmits an anode reset voltage (or a first initialization voltage) Var, a second electrode connected to the fifth node N5, and a gate electrode that receives the third scan signal SC3(n) .

The fifth and sixth transistors T5 and T6 can be turned on in response to the third scan signal SC3(n) , the bias voltage Vobs can be applied to the second node N2, and the anode reset voltage Var can be applied to the fifth node N5 (i.e., the anode electrode of the light emitting diode OD).

The seventh transistor T7 can include a first electrode connected to an initialization voltage line ViniL that transmits an initialization voltage Vini, a second electrode connected to the first node N1, and a gate electrode that receives the fourth scan signal SC4(n) .

The seventh transistor T7 can be turned on in response to the fourth scan signal SC4(n) and can apply the initialization voltage Vini to initialize the gate electrode of the driving transistor DT. Unnecessary charges can remain in the gate electrode of the driving transistor DT due to the high-potential driving voltage EVDD applied to the storage capacitor Cst. Thus, by applying the initialization voltage Vini to the gate electrode of the driving transistor DT through the seventh transistor T7, the remaining charges can be initialized.

The 8T1C structure of the pixel P described above is an example, and the pixel P of this exemplary implementation can be configured with a different structure.

Referring to FIG. 1, the timing control portion 240 can process image data Do input from a host system to be suitable for size and resolution of the display panel 100 and supply them to the data driving portion 220. The timing control portion 240 can generate a gate control signal GCS and a data control signal DCS using synchronization signals input from the host system, for example, a dot clock signal CLK, a data enable signal DE, a horizontal synchronization signal HSY, and a vertical synchronization signal VSY. By supplying the gate control signal GCS and the data control signal DCS generated in this way to the gate driving portion 210 and the data driving portion 220, respectively, the gate driving portion 210 and the data driving portion 220 can be controlled.

The timing control portion 240 can be configured to be combined with various processors, for example, a microprocessor, a mobile processor, an application processor, etc., depending on a device to be mounted.

Meanwhile, the host system can be, for example, a driving system that drives an electronic device to which the display apparatus 10 is applied. The electronic device can be, for example, one of a TV (Television), a navigation system, a monitor, a mobile device, and a wearable device, a household appliance, a build, a vehicle, a set-top box, a game machine, etc., without being limited thereto.

The gate driving portion 210 can receive the gate control signal GCS from the timing control portion 240, generate the gate signals, and sequentially apply the gate signals to the gate lines GL. For example, the gate signals can be sequentially output from the top to the bottom in the vertical direction, sequentially output from the bottom to the top in the vertical direction, or in an order other than the sequential order, without being limited thereto.

The gate driving portion 210 can be arranged, for example, on at least one side of the display region AA. In this exemplary implementation, a case is taken as an example in which the gate driving portion 210 is configured to include first and second gate driving portions 211 and 212 arranged on both sides of the display region AA, for example, on the left and right sides of the display region AA.

As an example, the gate driving portion 210 can be formed directly in the non-display region NA on the substrate of the display panel 100, for example, in a GIP (gate-in panel) structure. In this case, the gate driving portion 210 can be formed during processes of forming elements of the display panel 100, or can be formed is a process other the processes of forming elements of the display panel 100. Implementations are not limited thereto. As an example, the gate driving portion 210 can be provided on a separate panel or a separate film, and connected to the display panel 100 using a tape automated bonding (TAB) method, a chip-on-glass (COG) method, a chip-on-panel (COP) method, or a chip-on-film (COF) method, without being limited thereto.

The gate driving portion 210 configured with the GIP structure can include, for example, a first scan driving circuit that sequentially outputs the first scan signals SC1, a second scan driving circuit that sequentially outputs the second scan signals SC2, a third scan driving circuit that sequentially outputs the third scan signals SC3, a fourth scan driving circuit that sequentially outputs the fourth scan signal SC4, a first emission driving circuit that sequentially outputs the first emission control signals EM1, and a second emission driving circuit that sequentially outputs the second emission control signals EM2, without being limited thereto.

Each of the first scan driving circuit to the fourth scan driving circuit and the first and second emission driving circuits can be configured with a shift register including a plurality of stages that output respective signals, without being limited thereto.

The gate driving portion 210 is described with further reference to FIG. 3. FIG. 3 illustrates a part of the gate driving portion 210, and for convenience of explanation, a configuration of a portion of the gate driving portion 210 that drives the n-th horizontal line configured with a n-th odd horizontal line (or 2n−1-th horizontal line) and a n-th even horizontal line (or 2n-th horizontal line) of the display region AA is illustrated.

As an example, in the first gate driving portion 211 of the gate driving portion 210, for example, first, third, and fourth scan stages SSC1(n) , SSC3(n) , and SSC4(n) that constitute the first, third, and fourth scan driving circuits, respectively, first and second emission stages SEM1(n) and SEM2(n) that constitute the first and second emission driving circuits, respectively, and odd and even second scan stages SSC2_O(n) and SSC2_E(n) that constitute the second scan driving circuit can be arranged.

In addition, in the second gate driving portion 212 of the gate driving portion 210, for example, the first, third, and fourth scan stages SSC1(n) , SSC3(n) , and SSC4(n) that constitute the first, third, and fourth scan driving circuits, respectively, the first and second emission stages SEM1(n) and SEM2(n) that constitute the first and second emission driving circuits, respectively, and the odd and even second scan stages SSC2_O(n) and SSC2_E(n) that constitute the second scan driving circuit can be arranged.

In the gate driving portion 210, the odd and even second scan stages SSC2_O(n) and SSC2_E(n) constituting the second scan driving circuit can be arranged so as to be closest to the display region AA, and the second emission stage SEM2(n) can be arranged at the outermost part farthest from the display region AA. In addition, the first emission stage SEM1(n) can be arranged between the first to fourth scan stages SSC1(n) to SSC4(n) .

The arrangement of the first to fourth scan stages SSC1(n) to SSC4(n) and the first and second emission stages SEM1(n) and SEM2(n) shown in FIG. 3 is an example, and they can be arranged in various combinations in the first and second gate driving portions 211 and 212.

The first scan stage SSC1(n) can generate the first scan signal SC1(n) and output it to the corresponding first scan line SCL1. Accordingly, the pixel P_O(n) of the n-th odd horizontal line and the pixel P_E(n) of the n-th even horizontal line can be commonly applied with the first scan signal SC1(n) .

The odd second scan stage SSC2_O(n) can generate an odd second scan signal SC2_O(n) and output it to the corresponding odd second scan line SCL2, and the even second scan stage SSC2_E(n) can generate an even second scan signal SC2_E(n) and output it to the corresponding even second scan line SCL2. Accordingly, the pixel P_O(n) of the n-th odd horizontal line can be applied with the odd second scan signal SC2_O(n) , and the pixel P_E(n) of the n-th even horizontal line can be applied with the even second scan signal SC2_E(n). Here, the odd second scan signal SC2_O(n) and the even second scan signal SC2_E(n) can have different timings. For example, the odd second scan signal SC2_O(n) and the even second scan signal SC2_E(n) can be applied to a data writing period of the n-th odd horizontal line and a data writing period of the n-th even horizontal line immediately following it, respectively.

The third scan stage SSC3(n) can generate the third scan signal SC3(n) and output it to the corresponding third scan line SCL3. Accordingly, the pixels P_O(n) and P_E(n) of the n-th odd and even horizontal lines can be commonly applied with the third scan signal SC3(n).

The fourth scan stage SSC4(n) can generate the fourth scan signal SC4(n) and output it to the corresponding fourth scan line SCL4. Accordingly, the pixels P_O(n) and P_E(n) of the n-th odd and even horizontal lines can be commonly applied with the fourth scan signal SC4(n).

The first emission stage SEM1(n) can generate the first emission control signal EM1(n) and output it to the corresponding first emission control line EML1. Accordingly, the pixels P_O(n) and P_E(n) of the n-th odd and even horizontal lines can be commonly applied with the first emission control signal EM1(n).

The second emission stage SEM2(n) can generate the second emission control signal EM2(n) and output it to the corresponding second emission control line EML2. Accordingly, the pixels P_O(n) and P_E(n) of the n-th odd and even horizontal lines can be commonly applied with the second emission control signal EM2(n).

Meanwhile, referring to FIG. 3, the bias voltage line VobsL, the reset voltage line VarL, and the initialization voltage line ViniL can be arranged between the gate driving portion 210 and the display region AA. As an example, the bias voltage line VobsL and the initialization voltage line ViniL can be arranged between the first gate driving portion 211 and the display region AA, and the reset voltage line VarL can be arranged between the second gate driving portion 212 and the display region AA, without being limited thereto.

The bias voltage line VobsL, the reset voltage line VarL, and the initialization voltage line ViniL can respectively supply the bias voltage Vobs, the anode reset voltage Var, and the initialization voltage Vini from the power supply portion 280 to the pixels P within the display region AA.

In FIG. 3, each of the bias voltage line VobsL, the reset voltage line VarL, and the initialization voltage line ViniL is illustrated as being located only on the left or right side of the display region AA, but not limited thereto, and each of the bias voltage line VobsL, the reset voltage line VarL, and the initialization voltage line ViniL can be located on both sides, and even if located on one side, the location on the left or right side is not limited.

Furthermore, referring to FIG. 3, as an example, one or more optical regions OA1 and OA2 can be disposed in the display region AA, without being limited thereto. As an example, at least one or all of the one or more optical regions OA1 and OA2 can be omitted depending on the design. Although it is illustrated that the one or more optical regions OA1 and OA2 are arranged at an upper portion of the display region AA, implementations are not limited thereto. As an example, the one or more optical regions OA1 and OA2 can be located at various locations on the display region AA. As an example, the one or more optical regions OA1 and OA2 can be arranged at the same location or separate locations.

The one or more optical regions OA1 and OA2 can be arranged to overlap one or more optical electronic devices, for example, a photographing device such as a camera (or image sensor), and/or a detection sensor such as a proximity sensor and an illuminance sensor, without being limited thereto. For the operation of the optical electronic device, the one or more optical regions OA1 and OA2 can have a light-transmitting structure formed therein and can have transmittance of a certain level or higher. As an example, a number of pixels P per unit area in the one or more optical regions OA1 and OA2 can be smaller than a number of pixels P per unit area in a regular region excluding the optical regions OA1 and OA2 in the display region AA, without being limited thereto. As an example, a resolution of the one or more optical regions OA1 and OA2 can be lower than a resolution of the regular region within the display region AA, without being limited thereto. Implementations are not limited thereto. As an example, the one or more optical regions OA1 and OA2 can have a light-transmitting structure formed therein and can have transmittance of a level higher than the regular region within the display region AA, regardless of the resolution thereof, without being limited thereto.

Referring back to FIG. 1, the data driving portion 220 can receive the image data Do and the data control signal DCS from the timing control portion 240, and in response to the data control signal DCS, the data driving portion 220 can convert the image data Do into analog image data i.e., data voltages Vdata, and outputs them to the respective data lines DL.

The power supply portion 280 can generate DC power required for driving the pixel array and the driving circuit portion of the display panel 100 using, for example, a DC-DC converter. The DC-DC converter can include a charge pump, a regulator, a buck converter, a boost converter, etc.

The power supply portion 280 can receive, for example, a power voltage Vcc that is a driving voltage for driving the display apparatus (10) from the host system, and generate the DC voltages such as the gate low voltages VGL and VEL, the gate high voltages VGH and VEH, the high-potential driving voltage EVDD, and the low-potential driving voltage EVSS. The gate low voltages VGL and VEL and the gate high voltages VGH and VEH can be supplied to the gate driving portion 210. The high-potential driving voltage EVDD and the low-potential driving voltage EVSS can be supplied in common to the pixels P in the display panel 100.

As an example, the display apparatus 10 of this exemplary implementation configured as above can be driven at low power in the VRR method in which a refresh cycle (or refresh rate) is adjusted, in order to reduce power consumption.

In this regard, in a normal driving mode which is a high-speed driving mode, the display apparatus 10 can operate to refresh (or update) an image of the display panel 100 (or the data voltage Vdata applied to each pixel P) by frame FR. For example, in the high-speed driving

mode, the display apparatus 10 can be driven at a refresh rate of 120 Hz, so that a refresh operation can be performed for each of 120 frames FR per second. In this way, in the high-speed driving mode, all frames FR can be assigned as refresh frames FRr in which the data voltage Vdata is written. Implementations are not limited thereto. As an example, in the high-speed driving mode, the display apparatus 10 can be driven at a refresh rate of higher than or lower than 120 Hz. As an example, in the high-speed driving mode, the display apparatus 10 can be driven at a refresh rate of 60 Hz, 90 Hz, 165 Hz, 180 Hz, etc., without being limited thereto.

In the case of displaying a still image, etc., the display apparatus 10 can be driven in a low-speed driving mode. In the low-speed driving mode, the refresh rate is reduced, so that the refresh cycle of the display panel 100 becomes longer. For example, in the case of low-speed driving with a refresh rate of 10 Hz, one refresh frame FRr and 11 consecutive skip frames FRs can be alternately repeated. As such, in the low-speed driving mode, the frames FR can be divided into the refresh frame FRr in which the data voltage Vdata is written and the skip frame FRs in which the data voltage Vdata is not written and the writing is skipped.

As such, in the low-speed driving mode, as the driving frequency decreases, the cycle of the refresh frame FRr (or the interval between the refresh frames FRr) becomes longer, and one or more skip frames FRs exist between the refresh frames FRr.

During the skip frame FRs, the image refresh operation is stopped, so that power consumption can be reduced.

In the refresh frame FRr when the data voltage Vdata is written, the first scan signal SC1 to the fourth scan signal SC4 (more specifically, their scan pulses) can be applied during a non-emission period in order to write the data voltage Vdata to the corresponding pixel P.

In addition, in the skip frames FRs when the data voltage Vdata is not written and maintained, an operation of applying the bias voltage Vobs to alleviate hysteresis of the driving transistor DT and the anode reset voltage Var to reset the anode electrode of the light emitting diode OD can be performed. To this end, the third scan signal SC3 (more specifically, its scan pulse) for providing the bias voltage Vobs and the anode reset voltage Var to the pixel P can be applied.

The driving in the refresh frame FRr and the skip frame FRs of the VRR method can be described with further reference to FIGS. 4 and 5.

Meanwhile, in FIGS. 4 and 5, for convenience of explanation, the first and second emission control signals EM1(n) and EM2(n) are not individually illustrated, but rather one emission control signal EM(n) representing them is illustrated as an example.

First, referring to FIG. 4, the driving in the refresh frame FRr is described. The refresh frame FRr can be divided into a non-emission period Tne and an emission period Te. The non-emission period Tne of the refresh frame FRr can be referred to as a first non-emission period Tne1, and the emission period Te of the refresh frame FRr can be referred to as a first emission period Te1.

The first non-emission period Tne1 and the first emission period Te1 can be defined by the emission control signal EM(n) of the refresh frame FRr. In this regard, a scan pulse section of a high level, as a turn-off level, of the emission control signal EM(n) can correspond to the first non-emission period Tne1, and a section of a low level, as a turn-on level, of the emission control signal EM(n) can correspond to the first emission period Te1.

In the first non-emission period Tne1 of the refresh frame FRr, an operation in which the data voltage Vdata is applied and written can be performed.

In this regard, for example, during the data writing period (or sampling period) Tw when each of the odd and even second scan signals SC2_O(n) and SC2_E(n) is applied, more specifically, a scan pulse of a low level, as a turn-on level, of each of the odd and even second scan signals SC2_O(n) and SC2_E(n) is applied, the data voltage Vdata of each of the odd and even pixels P_O(n) and P_E(n) can be applied and written to the gate electrode of the driving transistor DT. Meanwhile, in the data writing period Tw, a threshold voltage of the driving transistor DT can be sampled and reflected to the gate electrode of the driving transistor DT.

In the data writing period Tw, the first scan signal SC1(n) can have a scan pulse of a high level, which is a turn-on level, so that the first transistor T1 can have a turn-on state.

Meanwhile, in the first non-emission period Tne, at least one bias period (or anode reset period) Tobs when the bias voltage Vobs and the anode reset voltage Var are applied can be located. In this exemplary implementation, a case where the bias periods Tobs are set before and after the data writing period Tw is taken as an example. In this case, for convenience of explanation, the bias period Tobs set before the data writing can be referred to as a first bias period Tobs1, and the bias period Tobs set after the data writing can be referred to as a second bias period Tobs2.

In each of the first and second bias periods Tobs1 and Tobs2, the third scan signal SC3(n) can have a scan pulse of a low level which is a turn-on level.

In this case, the fifth transistor T5 can be turned on, so that the bias voltage Vobs can be applied to the second node N2 and the third node N3. Through this, an on-bias stress operation for the driving transistor DT can be performed.

In addition, the sixth transistor T6 can be turned on, so that the anode reset voltage Var can be applied to the fifth node N5. Through this, an anode reset operation for the anode electrode of the light emitting diode OD can be performed.

Meanwhile, an operation of applying the initialization voltage Vini can be performed between the data writing period Tw and the first bias period Tobs1. In this initialization section Ti, the fourth scan signal SC4(n) can have a scan pulse of a high level which is a turn-on level. Accordingly, the seventh transistor T7 can be turned on, so that the initialization voltage Vini can be applied to the first node N1 i.e., the gate electrode of the driving transistor DT. Through this, an initialization operation for the driving transistor DT can be performed.

Next, referring to FIG. 5, the driving in the skip frame FRs is described. The skip frame FRs can be divided into a non-emission period Tne and an emission period Te. Here, the non-emission period Tne of the skip frame FRs can be referred to as a second non-emission period Tne2, and the emission period Te of the skip frame FRs can be referred to as a second emission period Te2.

The second non-emission period Tne2 and the second emission period Te2 can be defined by the emission control signal EM(n) of the skip frame FRs. In this regard, a scan pulse section of a high level, as a turn-off level, of the emission control signal EM(n) can correspond to the second non-emission period Tne2, and a section of a low level, as a turn-on level, of the emission control signal EM(n) can correspond to the second emission period Te2.

In the second non-emission period Tne2 of the skip frame FRs, the operation of writing the data voltage Vdata is not performed, so the data writing period Tw within the first non-emission period Tne1 of the refresh frame FRr is not set.

Accordingly, in the second non-emission period Tne2 of the skip frame FRs, the first scan signal SC1(n) related to the data writing operation can maintain a low level, which is a turn-off level, and the second scan signals SC2_O(n) and SC2_E(n) can maintain a high level which is a turn-off level.

In addition, in the second non-emission period Tne2 of the skip frame FRs, the initialization operation of applying the initialization voltage Vini is not performed, so the initialization period Ti within the first non-emission period Tne1 of the refresh frame FRr is not set.

Accordingly, in the second non-emission period Tne2 of the skip frame FRs, the fourth scan signal SC4(n) related to the initialization operation can maintain a low level which is a turn-off level.

Meanwhile, in the second non-emission period Tne2 of the skip frame FRs, a bias period Tobs when the bias voltage Vobs and the anode reset voltage Var are applied can be set. Here, for convenience of explanation, the bias period Tobs set within the second non-emission period Tne2 can be referred to as a third bias period Tobs3.

In the third bias period Tobs3, the third scan signal SC3(n) can have a scan pulse of a low level which is a turn-on level. Accordingly, an on-bias stress operation for the driving transistor DT and the anode reset operation for the anode electrode of the light emitting diode OD can be performed.

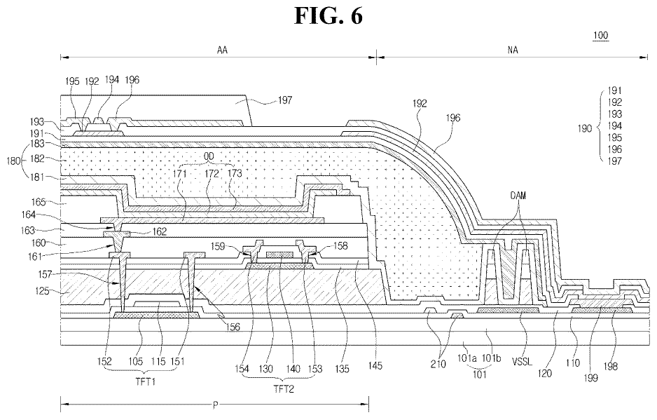

Hereinafter, an example of a cross-sectional structure of the display panel 100 of this exemplary implementation is described with further reference to FIG. 6. FIG. 6 is a cross-sectional view schematically illustrating an example of a cross-sectional structure of a display panel according to a first exemplary implementation of the present disclosure.

In FIG. 6, for convenience of explanation, two thin film transistors TFT1 and TFT2 are illustrated in the pixel P within the display region AA. Here, the thin film transistor TFT1 positioned relatively lower and closer to the substrate 101 is referred to as a first thin film transistor TFT1, which can be a polycrystalline silicon thin film transistor. The thin film transistor TFT2 positioned relatively upper and farther from the substrate 101 is referred to as a second thin film transistor TFT2, which can be an oxide thin film transistor. Implementations are not limited thereto. As an example, the first thin film transistor TFT1 and the second thin film transistor TFT2 can be disposed at the same level. As an example, the first thin film transistor TFT1 and the second thin film transistor TFT2 can be polycrystalline silicon thin film transistors, or oxide thin film transistors, etc., and can be transistors of a same type or of different types, without being limited thereto.

Meanwhile, the first thin film transistor TFT1 can be a driving transistor (DT of FIG. 2), but not limited thereto, and in FIG. 6, for convenience of explanation, a case in which the first thin film transistor TFT1 is connected to the light emitting diode OD is illustrated. In addition, the second thin film transistor TFT2 can be one of the first to seventh transistors (T1 to T7 of FIG. 2) that are switching thin film transistors, more specifically, the first transistor T1 connected to the storage capacitor Cst or the seventh transistor T7 connected to the gate electrode of the driving transistor DT, but not limited thereto.

The substrate 101 can be configured as, for example, a thin glass substrate (or glass film) or a plastic substrate (or plastic film) so as to implement a flexible characteristics of the display panel 100. Implementations are not limited thereto. As an example, the substrate 101 can be configured as a rigid substrate or a flexible substrate. As an example, the substrate 101 can be configured as a transparent substrate or an opaque substrate.

Here, in a case where the substrate 101 is configured as a glass substrate, for example, the substrate 101 can have a thickness of approximately 0.2 mm.

Meanwhile, in a case where the substrate 101 is configured as a plastic substrate, for example, the substrate 101 can include at least one polyimide layer, without being limited thereto. In this exemplary implementation, the substrate 101 configured of two polyimide layers, which are a first polyimide layer 101a and a second polyimide layer 101b, is taken as an example.

The first thin film transistor TFT1 can include a first semiconductor layer 105 disposed on the substrate 101, a first gate electrode 115 overlapping the semiconductor layer 105 with a first insulating layer 110 interposed therebetween, and a first source electrode 151 and a first drain electrode 152 located on a fourth insulating layer 145 over the first gate electrode 115. Here, the first semiconductor layer 105 can be formed of polycrystalline silicon, but not limited thereto.

The first semiconductor layer 105 can include a central channel region and source and drain regions on both sides thereof. The first source electrode 151 and the first drain electrode 152 can be connected to the source region and the drain region of the first semiconductor layer 105 through the first and second contact holes 156 and 157 that are formed in the insulating layers 110, 120, 125, 135, and 145 located below the first source electrode 151 and the first drain electrode 152.

A second insulating layer 120 can be formed on the first gate electrode 115 of the first thin film transistor TFT1.

A first interlayered insulating layer 125 can be formed on the second insulating layer 120. The second thin film transistor TFT2 can be formed on the first interlayered insulating layer 125.

The second thin film transistor TFT2 can include a second semiconductor layer 130 on the first interlayered insulating layer 125, a second gate electrode 140 overlapping the second semiconductor layer 130 with a third insulating layer 135 interposed therebetween, and a second source electrode 153 and a second drain electrode 154 located on the fourth insulating layer 145 over the second gate electrode 140. Here, the second semiconductor layer 130 can be formed of an oxide semiconductor, but not limited thereto.

The second semiconductor layer 130 can include a central channel region and source and drain regions on both sides thereof. The second source electrode 153 and the second drain electrode 154 can be connected to the source and drain regions of the second semiconductor layer 130 through third and fourth contact holes 158 and 159 formed in the insulating layers 135 and 145 located below the second source electrode 153 and the second drain electrode 154.

A second interlayered insulating layer (or first planarization layer) 160 can be formed on the second thin film transistor TFT2.

Here, the first, second, third, and fourth insulating layers 110, 120, 135, and 145 can be

formed of an inorganic insulating material such as silicon nitride or silicon oxide, but not limited thereto. As an example, the first, second, third, and fourth insulating layers 110, 120, 135, and 145 can be formed of the same material or different materials, without being limited thereto.

In addition, the first and second interlayered insulating layers 125 and 160 can be formed of an organic insulating material such as photo acrylic or benzocyclobutene, but not limited thereto.

A connection electrode 162 can be formed on the second interlayered insulating layer 160. The connection electrode 162 can be connected to the first drain electrode 152 through a contact hole 161 formed in the second interlayered insulating layer 160.

A third interlayered insulating layer (or second planarization layer) 163 can be formed on the connection electrode 162. The third interlayered insulating layer 163 can be formed of an organic insulating material such as photo acrylic or benzocyclobutene, but not limited thereto. As an example, the connection electrode 162 can be omitted depending on the design. In this case, as an example, one of the second interlayered insulating layer 160 and the third interlayered insulating layer 163 can be omitted, without being limited thereto.

The light emitting diode OD and a bank 165 can be formed on the third interlayered insulating layer 163.

The light emitting diode OD can include an anode electrode (or first electrode) 171, a light emitting layer 172, and a cathode electrode (or second electrode) 173.

The anode electrode 171 can be connected to the connection electrode 162 through the contact hole 164 formed in the third interlayered insulating layer 163. Alternatively, as an example, the anode electrode 171 can be connected to the first drain electrode 152 through a contact hole formed in the second interlayered insulating layer 160 and the third interlayered insulating layer 163, without the connection electrode 162. But the present disclosure is not limited thereto.

The bank 165 can be disposed along a boundary of the pixel P and can be formed to cover an edge of the anode electrode 171, without being limited thereto. The light emitting layer 172 can be formed on the anode electrode 171 exposed through an opening of the bank 165.

The cathode electrode 173 can be formed on the light emitting layer 172 and can be applied with the low-potential driving voltage (e.g., EVSS of FIG. 2).

An encapsulation layer 180 can be formed on the cathode electrode 173. The encapsulation layer 180 can include at least one inorganic encapsulation layer and at least one organic encapsulation layer, but not limited thereto. In this disclosure, a structure of the encapsulation layer 180, in which a first encapsulation layer 181, a second encapsulation layer 182, and a third encapsulation layer 183 are sequentially stacked, is described as an example.

The first encapsulation layer 181 can be formed on the substrate 101 on which the cathode electrode 173 is formed. The third encapsulation layer 183 can be formed on the substrate 101 on which the second encapsulation layer 182 is formed, and can be formed to surround an upper surface, a lower surface, and a side surface of the second encapsulation layer 182 together with the first encapsulation layer 181, without being limited thereto. The first encapsulation layer 181 and the third encapsulation layer 183 can reduce, minimize or prevent external moisture or oxygen from penetrating into the light emitting diode OD. The first encapsulation layer 181 and the third encapsulation layer 183 can be formed of an inorganic insulating material capable of low-temperature deposition, such as silicon nitride, silicon oxide, silicon oxynitride, or aluminum oxide, without being limited thereto.

The second encapsulating layer 182 can acts as a buffer to relieve stress between layers, for example, due to bending of the display apparatus 10, and can flatten steps between layers. The second encapsulation layer 182 can be formed on the substrate 101 on which the first encapsulation layer 181 is formed, using a non-photosensitive organic insulating material such as acrylic resin, epoxy resin, phenolic resin, polyamide resin, polyimide resin, polyethylene, or silicon oxycarbon (SiOC), or a photosensitive organic insulating material such as photo acrylic, but

not limited thereto. When the second encapsulation layer 182 is formed through an inkjet method, a dam DAM can be placed in the non-display region NA to reduce or prevent the second encapsulation layer 182 in liquid form from spreading to an edge of the substrate 101. The dam DAM can be disposed closer to the edge of the substrate 101 than the second encapsulation layer 182. By the dam DAM, the second encapsulation layer 182 can be reduced or prevented from spreading to a pad region, where a conductive pad is disposed, on an outermost edge of the substrate 101.

The dam DAM can be designed to reduce or prevent the spreading of the second encapsulation layer 182, but if the second encapsulation layer 182 is formed to exceed a height of the dam DAM during a process, the second encapsulation layer 182 as an organic layer can be exposed to an outside, so that moisture, etc. can easily penetrate into the light emitting element. To reduce or prevent this, 10 or more dam DAM can be formed in succession, but not limited thereto. As an example, one or more dam DAM can be formed.

As an example, the dam DAM can be formed simultaneously with the first interlayered insulating layer 125, the second interlayered insulating layer 160, and/or the third interlayered insulating layer 163, without being limited thereto. As an example, when forming the first interlayered insulating layer 125, a lower layer of the dam DAM can be formed together, and when forming the second and third interlayered insulating layers 160 and 163, an upper layer of the dam DAM can be formed together, so that the dam DAM can be formed in a triple laminated structure. As another example, the dam DAM can be formed with one or two of the first, second, and third interlayered insulating layers 125, 160, and 163. As another example, the dam DAM can be formed separately from the first, second, and third interlayered insulating layers 125, 160, and 163, without being limited thereto.

Accordingly, the dam DAM can be formed of the same material as the first interlayered insulating layer 125, the second interlayered insulating layer 160, and the third interlayered insulating layer 163, but not limited thereto.

As an example, the dam DAM can be formed to overlap a low-potential driving voltage line VSSL, without being limited thereto. For example, the low-potential driving voltage line VSSL can be formed at a lower layer of a region, where the dam DAM is located, in the non-display region NA.

The low-potential driving voltage line VSSL and the gate driving portion 210 configured in the GIP structure can be formed along a periphery of the display panel 100, and the low-potential driving voltage line VSSL can be located outside the gate driving portion 210, without being limited thereto. In addition, the low-potential driving voltage line VSSL can be connected to the cathode electrode 173 to apply the low-potential driving voltage EVSS. The gate driving portion 210 is simply shown in a planar and cross-sectional manner in the drawings, but can be configured with the same structure as the first thin film transistor TFT1 and/or the second thin film transistor TFT2 of the display region AA, without being limited thereto.

A touch layer (or touch element layer) 190 can be disposed on the encapsulation layer 180. In the touch layer 190, a touch buffer layer 191 can be positioned between a touch sensor metal including touch electrode connection lines 192 and 194 and touch electrodes 195 and 196, and the cathode electrode 173 of the light emitting diode OD. As an example, the touch layer 190 can be omitted depending on the design.

The touch buffer layer 191 can block a chemical solution (developer, etchant, etc.) used in a manufacturing process of the touch sensor metal disposed on the touch buffer layer 191 or moisture from the outside from penetrating into the light emitting layer 172 containing an organic

material. Accordingly, the touch buffer layer 191 can reduce or prevent damage to the light emitting layer 172 that is vulnerable to the chemical solution or moisture.

According to a mutual-capacitance-based touch sensor structure, the touch electrodes 195 and 196 can be disposed on the touch buffer layer 191, and the touch electrodes 195 and 196 can be arranged to cross each other.

The touch electrode connection lines 192 and 194 can electrically connect the touch electrodes 195 and 196. One of the touch electrode connection lines 192 and 194, and the touch electrodes 195 and 196 can be located at different layers with a touch insulation layer 193 interposed therebetween. In addition, one of the touch electrode connection lines 192 and 194 and

the other of the touch electrode connection lines 192 and 194 can be located at different layers with the touch insulation layer 193 interposed therebetween.

The touch electrode connection lines 192 and 194 can be arranged to overlap the bank 165, thereby reducing or preventing decrease in aperture ratio, but not limited thereto.

Meanwhile, a part of the touch electrodes 195 and 196 and a part of the touch electrode connection line 192 can extend along the top and side surfaces of the encapsulation layer 180 and the top and side surfaces of the dam DAM and be electrically connected to a touch driving circuit through a touch pad 198 and 199.

A part of the touch electrodes 195 and 196 and a part of the touch electrode connection line 192 can receive a touch driving signal from the touch driving circuit and transmit it to the touch electrodes 195 and 196, and can transmit a touch sensing signal detected by the touch electrodes 195 and 196 to the touch driving circuit.

In this regard, for example, a driving IC (e.g., data IC, etc.) of the data driving portion 220 including the touch driving circuit can be configured in a COF type and connected to the non-display region NA of the substrate 101 of the display panel 100, and in this case, an end of the touch pad 198 and 199 can be connected to a flexible circuit film on which the driving IC is mounted, so that a signal can be transmitted. But the present disclosure is not limited thereto.

A touch protective layer 197 can be disposed on the touch electrodes 195 and 196. In the drawing, the touch protective layer 197 is shown as being disposed only on the touch electrodes 195 and 196, but not limited thereto, and the touch protective layer 197 can extend before or after the dam DAM to be disposed on the touch electrode connection line 192.

In addition, as an example, a color filter can be disposed on the encapsulation layer 180. The color filter can be positioned on the touch layer 190, or between the encapsulation layer 180 and the touch layer 190. As an example, the color filter can be omitted depending on the design.

Meanwhile, in this exemplary implementation, a scan driving circuit of the gate driving portion 210, which generates a scan signal applied to a transistor configured with an oxide semiconductor within the pixel P, can be configured to generate the scan signal using a clock and a transistor configured with an oxide semiconductor, without a separate inverter circuit.

As such, the scan driving circuit can generate the corresponding scan signal without using an inverter circuit, so a number of transistors in the scan driving circuit can be reduced, and thus the scan driving circuit can be designed to be simple and have a small size (or small area). This can allow the gate driving portion 210 to be reduced in size, thereby reducing a width of a bezel of the display apparatus 10, thereby achieving a narrow bezel.

In this exemplary implementation, the scan driving circuit that does not include an inverter circuit can be, for example, the first scan driving circuit that generates the first scan signal SC1 applied to the first transistor T1 of the pixel P and/or the fourth scan driving circuit that generates the fourth scan signal SC4 applied to the seventh transistor T7 of the pixel P.

The structure and operation of the scan driving circuit excluding the inverter circuit can be described in more detail below.

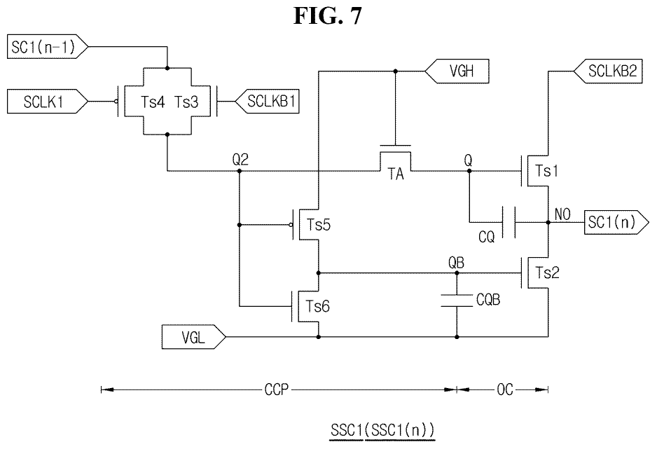

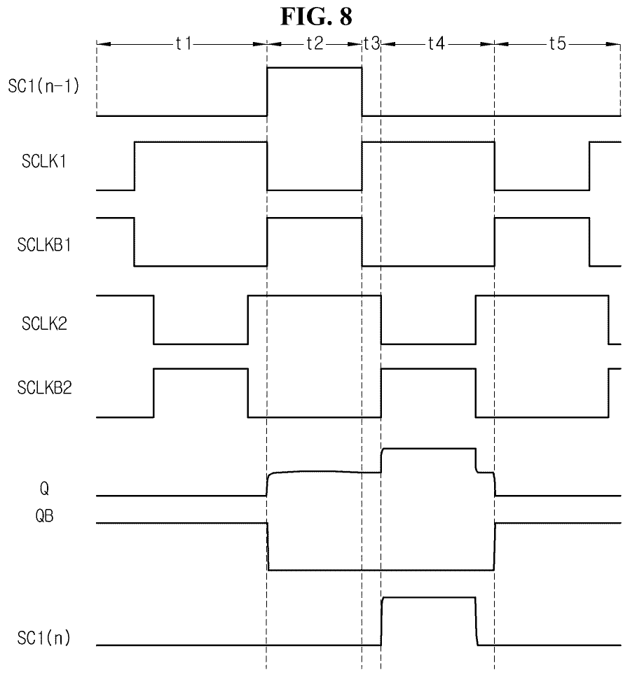

FIG. 7 is a view schematically illustrating an example of a structure of a scan driving circuit according to a first exemplary implementation of the present disclosure. FIG. 8 is a waveform view schematically illustrating timings of signals driving a scan driving circuit of FIG. 7.

In FIG. 7, for convenience of explanation, the first scan stage SSC1(n) arranged in the n-th horizontal line among the first scan stages SSC1 forming the first scan driving circuit that generates the first scan signals SC1 is illustrated as an example. In FIG. 8, the first scan signal SC1(n) (more specifically, its scan pulse) output from the first scan stage SSC1(n) of the n-th horizontal line of FIG. 7 is illustrated as an example.

Meanwhile, the fourth scan driving circuit that generates the fourth scan signal SC4 can be configured and driven similarly to the first scan driving circuit.

Referring to FIGS. 7 and 8 along with FIGS. 1 to 6, the first scan driving circuit can include the plurality of first scan stages SSC1 that respectively output the first scan signals SC1 to the plurality of first scan lines SCL1 arranged in the display region AA.

Regarding the configuration of the first scan stage SSC1, taking the n-th first scan stage SCC1(n) as an example, it can include an output portion OC and a control portion CCP that controls an output operation of the output portion OC.

In this regard, the output portion OC can include, for example, a pull-up transistor (or Q transistor) Ts1, a pull-down transistor (or QB transistor) Ts2, a Q capacitor CQ, and a QB capacitor CQB.

The control portion CCP can include, for example, a transfer transistor TA and a plurality of control transistors Ts3, Ts4, Ts5 and Ts6. The plurality of control transistors Ts3, Ts4, Ts5 and Ts6 can include, for example, first, second, third and fourth control transistors (or eighth, ninth, tenth, and eleventh transistors) Ts3, Ts4, Ts5 and Ts6.

Each of the plurality of transistors Ts1 to Ts6 and TA constituting the first scan stage SSC1(n) can be a P-type transistor or an N-type transistor. Each of the plurality of transistors Ts1 to Ts6 and TA constituting the first scan stage SSC1(n) can be a transistor using an oxide semiconductor or a transistor using polycrystalline silicon, or a transistor using other semiconductor such as a compound semiconductor, an oxide semiconductor, an amorphous silicon semiconductor, etc. As an example, the plurality of transistors Ts1 to Ts6 and TA constituting the first scan stage SSC1(n) can be the transistors of the same type or the transistors of different types. As an example, the plurality of transistors Ts1 to Ts6 and TA constituting the first scan stage SSC1(n) can be transistors using the same semiconductor or different semiconductors.

In this exemplary implementation, an example is given in which, among the plurality of transistors Ts1 to Ts6 and TA constituting the first scan stage SSC1(n) , the pull-up transistor Ts1, the pull-down transistor Ts2, the transfer transistor TA, and the first and fourth control transistors Ts3 and Ts6 are configured as N-type transistors including an oxide semiconductor layer, and the second and third control transistors Ts4 and Ts5 are configured as P-type transistors

including a polycrystalline silicon layer.

Here, the N-type transistors Ts1, Ts2, Ts3, Ts6 and TA of the oxide semiconductor can be formed, for example, with the same structure as the N-type transistors T1 and T7 of the oxide semiconductor in the pixel P. The P-type transistors Ts5 and Ts6 of polycrystalline silicon can be formed, for example, with the same structure as the P-type transistors T2 to T6 and DT of polycrystalline silicon in the pixel P. But implementations are not limited thereto. As an example, at least one or each of the N-type transistors Ts1, Ts2, Ts3, Ts6 and TA of the oxide semiconductor can be formed with a structure different from that of the N-type transistors T1 and T7 of the oxide semiconductor in the pixel P, or at least one or each of the P-type transistors Ts5 and Ts6 of polycrystalline silicon can be formed with a structure different from that of the P-type transistors T2 to T6 and DT of polycrystalline silicon in the pixel P.

The pull-up transistor Ts1 of the output portion OC can pull-up drive an output terminal NO of the first scan stage SSC1(n) in response to a signal of the Q node applied to its gate electrode. In addition, the pull-down transistor Ts2 can pull-down drive the output terminal NO in response to a signal of the QB node applied to its gate electrode.

The N-type pull-up transistor Ts1 can have, for example, a second electrode (or drain electrode) receiving a corresponding scan clock SCLKB2 and a first electrode (or source electrode) connected to the output terminal NO of the first scan stage SSC1(n) . Here, the scan clock SCLKB2 input to the pull-up transistor Ts1 can be referred to as a second B scan clock SCLKB2. At this time, the second B scan clock SCLKB2 can be a clock signal with a waveform that is opposite in phase to a second scan clock SCLK2.

In addition, the N-type pull-down transistor Ts2 can have, for example, a second electrode (or drain electrode) connected to the output terminal NO and a first electrode (or source electrode) provided with a gate low voltage VGL output from the power supply portion 280.

Meanwhile, the transfer transistor TA of the control portion CCP can transfer charges of a Q2 node to the Q node in response to a gate high voltage VGH. The N-type transfer transistor TA can have, for example, a gate electrode applied with the gate high voltage VGH, a first electrode (or source electrode) connected to the Q node, and a second electrode (or drain electrode) connected to the Q2 node.

The first control transistor Ts3 can provide a previous first scan signal SC1(n−1) , which is an output signal of the previous first scan stage SSC1, to the Q2 node in response to the corresponding scan clock SCLKB1. The N-type first control transistor Ts3 can have, for example, a gate electrode to which the scan clock SCLKB1 is applied, a first electrode (or source electrode)

connected to the Q2 node, and a second electrode (or drain electrode) to which the previous stage first scan signal SC1(n−1) is applied. Here, the scan clock SCLKB1 input to the first control transistor Ts3 can be referred to as a first B scan clock SCLKB1.

The second control transistor Ts4 can be connected in parallel with the first control transistor Ts3 and can provide the previous first scan signal SC1(n−1) , which is the output signal of the previous first scan stage SSC1, to the Q2 node in response to the corresponding scan clock SCLK1. The P-type second control transistor Ts4 can have, for example, a gate electrode to which the scan clock SCLK1 is applied, a second electrode (or drain electrode) connected to the Q2 node, and a first electrode (or source electrode) to which the previous first scan signal SC1(n−1) is applied. Here, the scan clock SCLK1 input to the second control transistor Ts4 can be referred to as a first scan clock SCLK1.

Here, the previous first scan signal SC1(n−1) applied to the first and second control transistors Ts3 and Ts4 can be used as a start signal (or carry signal). Meanwhile, when the first scan stage SSC1(n) is a scan stage of a first horizontal line, a start signal provided from the timing control portion 240 can be input to the first and second control transistors Ts3 and Ts4 to start its output operation.

Meanwhile, the first scan clock SCLK1 and the first B scan clock SCLK1B can be clock signals having waveforms with opposite phases. In addition, the first scan clock SCLK1 can have a different phase from the second scan clock SCLK2.

The third control transistor Ts5 can transmit the gate high voltage VGH to the QB node in response to the voltage of the Q2 node. The P-type third control transistor Ts5 can have, for example, a gate electrode connected to the Q2 node, a second electrode (or drain electrode) connected to the QB node, and a first electrode (or source electrode) to which the gate high voltage VGH is applied.

The fourth control transistor Ts6 can be connected in series with the third control transistor Ts5 with the QB node interposed therebetween, and can transmit the gate low voltage VGL to the QB node in response to the voltage of the Q2 node. The N-type fourth control transistor Ts6 can have, for example, a gate electrode connected to the Q2 node, a second electrode (or drain electrode) connected to the QB node, and a first electrode (or source electrode) to which the gate low voltage VGL is applied.

Meanwhile, the Q capacitor CQ can be connected between the Q node and the output terminal NO, and the QB capacitor CQB can be connected between the QB node and a line transmitting the gate low voltage VGL. Here, a capacitance of the Q capacitor CQ and a capacitance of the QB capacitor CQB can be set to be larger than a capacitance of the storage capacitor Cst in the pixel P.

The first scan stage SSC1(n) configured as described above can shift the previous first scan signal SC1(n−1) according to the three scan clocks SCLK1, SCLKB1 and SCLKB2 input thereto, and can output its first scan signal SC1(n) to the first scan line SCL1 of the n-th horizontal line.

In this way, the first scan stage SSC1(n) of the n-th horizontal line can operate by receiving the first scan clock SCLK1, the first B scan clock SCLKB1, and the second B scan clock SCLKB2.

Meanwhile, the first scan stages SSC1 located on the n−1-th and n+1-th horizontal lines, which are preceding and following the n-th horizontal line, can operate by receiving their corresponding three scan clocks, for example, the second scan clock SCLK2, the second B scan clock SCLKB2, and the first B scan clock SCLKB1. For example, in each of the first scan stages SSC1 located on the n−1-th and n+1-th horizontal lines, the pull-up transistor Ts1 can be configured to receive the first B scan clock SCLKB1, and the first and second control transistors Ts3 and Ts4 can be configured to receive the second B scan clock SCLKB2 and the second scan clock SCLK2, respectively.

The output operation of the first scan signal SC1(n) from the n-th first scan stage SSC1(n) can be described with further reference to FIG. 8.

As mentioned above, the n-th first scan stage SSC1(n) can receive the corresponding three scan clocks, the first, first B, and second scan clocks SCLK1, SCLKB1 and SCLKB2 to output the corresponding first scan signal SC1(n) .

For example, during a first period t1, the previous first scan signal SC1(n−1) can be in a low state. Within the first period t1, the first scan clock SCLK1 can transition from a low state to a high state, and conversely, the first B scan clock SCLKB1 can transition from a high state to a low state.

Here, during a section in which the first scan clock SCLK1 is in a low state and the first B scan clock SCLKB1 is in a high state, the first and second control transistors Ts3 can Ts4 can be turned on, so that a low voltage (i.e., the gate low voltage VGL) of the previous first scan signal SC1(n−1) can be applied to the Q2 node. Accordingly, the voltage of the Q2 node can become a low level.

After that, in a section where the first scan clock SCLK1 is high and the first B scan clock SCLKB1 is low, the first and second control transistors Ts3 and Ts4 can be turned off and the voltage of the Q2 node can be maintained at a low level.

As such, in the first period t1, the low voltage of the previous first scan signal SC1(n−1) can be transmitted to the Q2 node, so that the Q2 node can be set to a low state.

In this case, the voltage at the Q2 node can be transferred to the Q node through the turned-on transfer transistor TA, causing the Q node to become low.

In response to the low voltage at the Q2 node, the third control transistor Ts5 can be turned on and the fourth control transistor Ts6 can be turned off. Accordingly, the gate high voltage VGH can be transferred to the QB node through the turned-on third control transistor Ts5, causing the QB node to become high.

As such, during the first period t1, the Q node can become low and the QB node can become high. Accordingly, the pull-up transistor Ts1 can be turned off and the pull-down transistor Ts2 can be turned on, allowing the gate low voltage VGL to be output to the output terminal NO through the pull-down transistor Ts2. Thus, the low-level first scan signal SC1(n) can be applied to the first scan line SCL1 of the n-th horizontal line.

Next, in the second period t2, the previous first scan signal SC1(n−1) can be switched to a high state. During the second period t2, the first scan clock SCLK1 can have a low state, and conversely, the first B scan clock SCLKB1 can have a high state.

In this case, the first and second control transistors Ts3 and Ts4 can be turned on, so that a high voltage (i.e., the gate high voltage VGH) of the previous first scan signal SC1(n−1) can be applied to the Q2 node. Accordingly, the voltage of the Q2 node can be at a high level during the second period t2.

In this case, the voltage of the Q2 node can be transferred to the Q node through the turned-on transfer transistor TA, so that the Q node can be in a high state.

In addition, in response to the high voltage of the Q2 node, the third control transistor

Ts5 can be turned off and the fourth control transistor Ts6 can be turned on. Accordingly, the gate low voltage VGL can be transferred to the QB node through the turned-on fourth control transistor Ts6, so that the QB node can be in a low state.

As such, in the second period t2, the Q node can be in a high state and the QB node can be in a low state. Accordingly, the pull-up transistor Ts1 can be turned on and the pull-down transistor Ts2 can be turned off, so that the second B scan clock SCLKB2 can be output to the output terminal NO through the pull-up transistor Ts1.

Here, during the second period t2, the second B scan clock SCLKB2 can have a low-level voltage (i.e., gate low voltage VGL), so that the low-level first scan signal SC1(n) can be applied to the first scan line SCL1 of the n-th horizontal line.

As above, corresponding to the high section of the previous first scan signal SC1(n−1) , the low-level section of the first scan clock SCLK1 that controls the second control transistor Ts4 and the high-level section of the first B scan clock SCLKB1 that controls the first control transistor Ts3 can be set. As an example, the high section of the previous first scan signal SC1(n−1) can be set to substantially coincide with (or have substantially the same timing as) the low section of the first scan clock SCLK1 and the high section of the first B scan clock SCLKB1.

Next, in the third period t3, the previous first scan signal SC1(n−1) can be switched to a low state. During the third period t3, the first scan clock SCLK1 can be in a high state, and conversely, the first B scan clock SCLKB1 can be in a low state.

In this case, the first and second control transistors Ts3 and Ts4 can be turned off. Accordingly, during the third period t3, the Q2 node can be maintained in a high state, the Q node can be maintained in a high state, and the QB node can be maintained in a low state.

As such, in the third period t3, the Q node can be in a high state and the QB node can be in a low state. Accordingly, the pull-up transistor Ts1 can be maintained in a turned-on state and the pull-down transistor Ts2 can be maintained in a turned-off state, so that the second B scan clock SCLKB2 can be continuously output to the output terminal NO through the pull-up transistor Ts1.

Here, during the third period t3, the second B scan clock SCLKB2 can continue to have the low-level voltage (i.e., gate low voltage VGL), so that the first scan signal SC1(n) at the low-level can be continuously applied to the first scan line SCL1 of the n-th horizontal line.

Here, the low section of the second B scan clock SCLKB2 input to the pull-up transistor Ts1 can be set to a width greater than the high section of the previous first scan signal SC1(n−1) . In addition, the high section of the second B scan clock SCLKB2 input to the pull-up transistor Ts1 can be set to a width less than the low section of the first B scan clock SCLKB1. Furthermore, the high section of the second B scan clock SCLKB2 and the high section of the first B scan clock SCLKB1 can be set to be separated by a certain time, for example, the third period t3.

Next, in the fourth period t4, the previous first scan signal SC1(n−1) can be maintained in a low state. During the fourth period t4, the first scan clock SCLK1 can be maintained in a high state, and conversely, the first B scan clock SCLKB1 can be maintained in a low state.

In this case, the first and second control transistors Ts3 and Ts4 can be turned off. Accordingly, during the fourth period t4, the Q2 node can be maintained in a high state, the Q node can be maintained in a high state, and the QB node can be maintained in a low state.

As such, during the fourth period t4, the Q node can have a high state and the QB node can have a low state. Accordingly, the pull-up transistor Ts1 can be maintained in a turned-on state and the pull-down transistor Ts2 can be maintained in a turned-off state, so that the second B scan clock SCLKB2 can be output to the output terminal NO through the pull-up transistor Ts1.

Here, the second B scan clock SCLKB2 can have a pulse of a high voltage (i.e., gate high voltage VGH) within the fourth period t4, so that the high-level first scan signal SC1(n) can be applied to the first scan line SCL1 of the n-th horizontal line. As an example, within the fourth period t4, a scan pulse of the gate high voltage VGH can be generated for the first scan signal SC1(n) and can be applied to the first scan line SCL1 of the n-th horizontal line.

While the first scan signal SC1(n) of the gate high voltage VGH is output from the output terminal NO, the Q node can be bootstrapped by the Q capacitor CQ, so that the voltage of the Q node can be substantially increased to a voltage higher than the gate high voltage VGH. Due to the increase in the voltage of the Q node through the bootstrapping action, the second B scan clock SCLKB2 can be stably output to the output terminal NO.

Meanwhile, in the fourth period t4, when the second B scan clock SCLKB2 switches to a low voltage, the voltage of the output terminal NO can switch to a low voltage, so that the first scan signal SC1(n) at a low level can be output. In addition, the voltage of the Q node can be substantially lowered to the gate high voltage by the Q capacitor CQ.

Next, in the fifth period t5, the previous first scan signal SC1(n−1) can be maintained in a low state. During the fifth period t5, the first scan clock SCLK1 can have a low section and then switch to a high section, and conversely, the first B scan clock SCLKB1 can have a high section and then switch to a low section.

Here, in the section when the first scan clock SCLK1 is low and the first B scan clock SCLKB1 is high, the first and second control transistors Ts3 and Ts4 can be turned on, so that the low voltage of the previous first scan signal SC1(n−1) can be applied to the Q2 node. Accordingly, the voltage of the Q2 node can become a low level.

Thereafter, in the section when the first scan clock SCLK1 is high and the first B scan clock SCLKB1 is low, the first and second control transistors Ts3 and Ts4 can be turned off, and the voltage of the Q2 node can be maintained at a low level.

In this way, during the fifth period t5, similar to the first period t1, the low voltage of the previous first scan signal SC1(n−1) can be transmitted to the Q2 node, thereby setting the Q2 node to a low state.

In this case, the voltage at the Q2 node can be transmitted to the Q node through the turned-on transfer transistor TA, thereby setting the Q node to a low state.

In response to the low voltage at the Q2 node, the third control transistor Ts5 can be turned on and the fourth control transistor Ts6 can be turned off. Accordingly, the gate high voltage VGH can be transmitted to the QB node through the turned-on third control transistor Ts5, thereby setting the QB node to a high state.

As such, during the fifth period t5, the Q node can be in a low state and the QB node can be in a high state. Accordingly, the pull-up transistor Ts1 can be turned off and the pull-down transistor Ts2 can be turned on, so that the gate low voltage VGL can be output through the output terminal NO. Therefore, the low-level first scan signal SC1(n) can be applied to the first scan line SCL1 of the n-th horizontal line.

Through the above operation, the first scan signal SC1(n) can be stably output to the corresponding first scan line SCL1 from the n-th first scan stage SSC1(n) .

The first scan signal SC1(n) generated in this way can be provided to the pixel P of the corresponding horizontal line through the first scan line SCL1.

Meanwhile, when the display apparatus 10 is driven in a low-speed mode in the VRR method, the refresh operation of the pixel P is not performed during the skip frame FRs, so that the first scan signal SC1 can be maintained in a low state, as illustrated in FIG. 5. In addition, even during a blank period between adjacent frames FR, the first scan signal SC1 can be maintained in a low state.

Regarding the output of the low-level of the first scan signal SC1(n) during the skip frame FRs and the blank period, for example, the first and second scan clocks SCLK1 and SCLK2 can be maintained in a high state, and the first B and second B scan clocks SCLKB1 and SCLKB2 can be maintained in a high state (or low state).

In this case, the first control transistor Ts3 of the first scan stage SSC1 can be maintained in a turned-on state, and the Q2 node and the Q node can be maintained in a low state.

Furthermore, the third control transistor Ts5 can be maintained in a turned-on state, and the fourth control transistor Ts6 can be maintained in a turned-off state, so that the gate high voltage VGH can be continuously applied to the QB node through the third control transistor Ts5. As a result, the QB node can be maintained in a high state.

Accordingly, during the skip frame FRs and the blank period, the first scan signal SC1 can be maintained in a continuously low state.

As discussed above, according to this exemplary implementation, the scan driving circuit of the gate driving portion, which generates the scan signal applied to the transistor configured with oxide semiconductor in the pixel, can include the transistors configured with oxide semiconductor and can receive the multiple clock signals and output the scan signal.

As such, the scan driving circuit can generate the scan signal using the scan clocks and the transistors configured with oxide semiconductor, without requiring a separate inverter circuit configured of an CMOS.

Accordingly, a number of transistors in the scan driving circuit can be reduced, and thus the scan driving circuit can be designed to be simple and have a small size (or small area).

For example, a scan driving circuit using an inverter circuit has ten transistors, including two transistors constituting the inverter circuit, and compared to this, this exemplary implementation can result in a reduction by three transistors.

Accordingly, a size of the gate driving portion can be reduced, thereby reducing the width of the bezel, thereby enabling a narrow bezel.

Furthermore, since a number of transistors can be reduced, a power required to drive the reduced number of transistors can be reduced, thereby reducing power consumption and enabling low-power operation.

### Second Implementation:

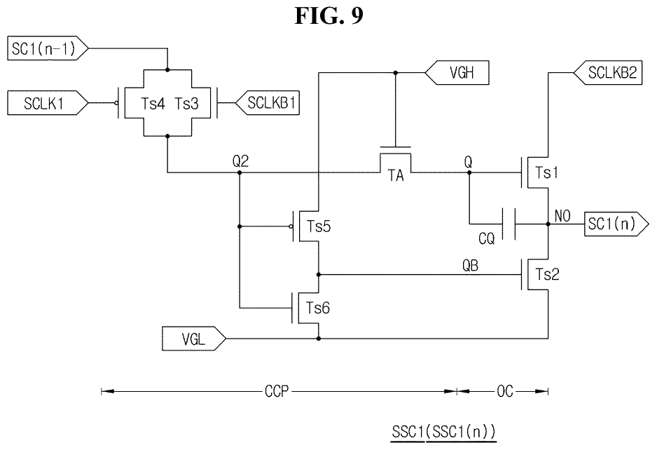

FIG. 9 is a view schematically illustrating an example of a structure of a scan driving circuit according to a second exemplary implementation of the present disclosure.

In the following description, detailed explanations of components identical to or similar to those of the first exemplary implementation described above can be omitted or briefly given.

Similar to the first exemplary implementation, in a gate driving portion of this exemplary implementation, a scan driving circuit of the gate driving portion that generates a scan signal applied to a transistor formed of an oxide semiconductor in a pixel can include a transistor formed of an oxide semiconductor and can receive a plurality of clock signals and output the scan signal.

However, unlike the first exemplary implementation, a QB capacitor (CQB of FIG. 7) can be removed from the scan stages constituting the scan driving circuit. This is described with reference to FIG. 9.

In FIG. 9, for convenience of explanation, the first scan stage SSC1(n) arranged on the n-th horizontal line among the first scan stages SSC1 forming the first scan driving circuit, which generates the first scan signals SC1, is illustrated as an example.

Meanwhile, the fourth scan driving circuit, which generates the fourth scan signals, can be configured and driven similarly to the first scan driving circuit.

The first scan driving circuit can include a plurality of first scan stages SSC1 that respectively output the first scan signals SC1 to a plurality of first scan lines arranged in the display region.

Similar to the first exemplary implementation, in the first scan stage SSC1, the output portion OC can include a pull-up transistor (or Q transistor) Ts1, a pull-down transistor (or QB transistor) Ts2, and a Q capacitor CQ. As such, the output portion OC of this exemplary implementation is not provided with a QB capacitor (CQB of FIG. 7).

Similar to the first exemplary implementation, the control portion CCP can include a transfer transistor TA and a plurality of control transistors Ts3, Ts4, Ts5 and Ts6. The plurality of control transistors Ts3, Ts4, Ts5 and Ts6 can include, for example, first, second, third, and fourth control transistors (or eighth, ninth, tenth, and eleventh transistors) Ts3, Ts4, Ts5, and Ts6.

Similar to the first exemplary implementation, the first scan stage SSC1(n) configured as described above can shift the previous first scan signal SC1(n−1) according to the three scan clocks SCLK1, SCLKB1 and SCLKB2 input thereto, and output the corresponding first scan signal SC1(n) to the corresponding first scan line.

As described above, the first scan stage SSC1 of this exemplary implementation can omit the QB capacitor for maintaining a voltage of the QB node.

Even if the QB capacitor is omitted, the first scan stage SSC1 can substantially operate normally.

In this regard, the QB capacitor is a component for maintaining the voltage of the QB node, and is particularly required to maintain the QB node in a low state for a long time.

For example, when driving in a low-speed mode in a VRR method, the first scan signal SC1 is continuously maintained in a low state for a plurality of skip frames (FRs in FIG. 5), and for this purpose, the QB node needs to be continuously maintained in a high state so that the pull-down transistor Ts2 has a turn-on state. For this purpose, the QB capacitor is connected to the QB node to maintain the voltage of the QB node.

However, according to this exemplary implementation, as mentioned in the first exemplary implementation above, the first and second scan clocks SCLK1 and SCLK2 can be maintained in a high state and the first B and second B scan clocks SCLKB1 and SCLKB2 can be maintained in a high state (or low state) during the skip frame (and blank period).

In this case, the first control transistor Ts3 of the first scan stage SSC1 can be maintained in a turned-on state, and the Q2 node and Q node can be maintained in a low state.

Furthermore, the third control transistor Ts5 can be maintained in a turned-on state, and the fourth control transistor Ts6 can be maintained in a turned-off state, so that the gate high voltage VGH can be continuously applied to the QB node through the third control transistor Ts5.

As such, the gate high voltage VGH can be continuously transferred to the QB node, allowing the QB node to maintain a high state.

As such, according to the configuration and operation of the first scan stage SSC1, the QB node can continuously maintain a high state.

Therefore, even if the QB capacitor, which serves to maintain the high state of the QB node during a long-term operation, is omitted, the QB node can continuously maintain a high state due to the gate high voltage VGH continuously input thereto.

Accordingly, in this exemplary implementation, the QB capacitor can be removed from the first scan stage, and thus the first scan driving circuit can be designed more simply and with a smaller size.

Therefore, the size of the gate driving can be further reduced, thereby further reducing the width of the bezel, thereby enabling a narrow bezel.

### Third Implementation:

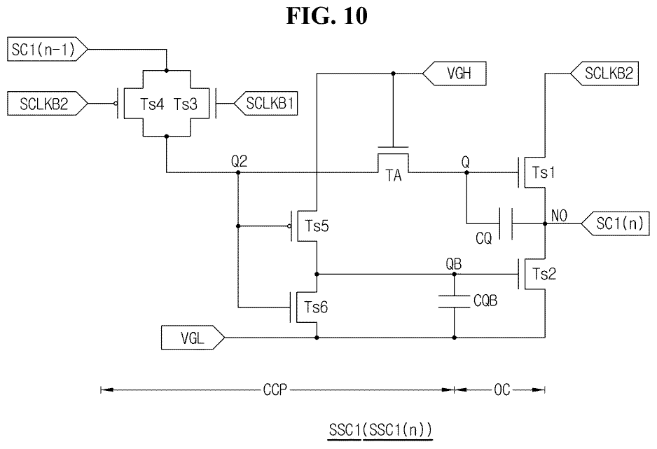

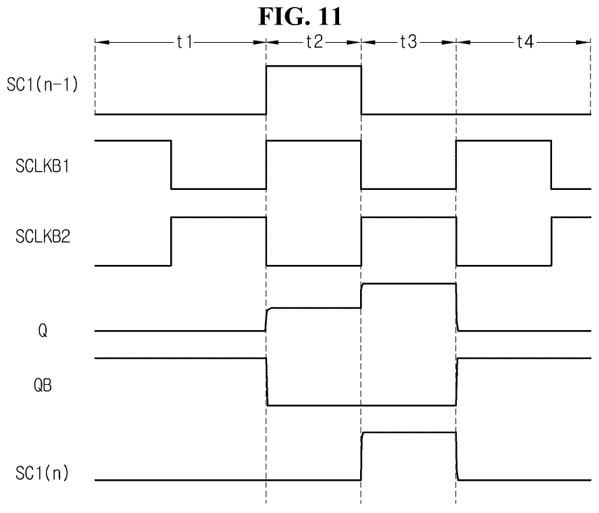

FIG. 10 is a view schematically illustrating an example of a structure of a scan driving circuit according to a third exemplary implementation of the present disclosure. FIG. 11 is a waveform view schematically illustrating timings of signals driving a scan driving circuit of FIG. 10.

In the following description, detailed explanations of components identical or similar to those of the first and second exemplary implementations described above can be omitted or briefly given.

Similar to the first and second exemplary implementations, in a gate driving portion of this exemplary implementation, a scan driving circuit of the gate driving portion that generates a scan signal applied to a transistor formed of an oxide semiconductor provided in a pixel can include a transistor formed of an oxide semiconductor and can receive a plurality of clock signals and output the scan signal.

However, unlike the first and second exemplary implementations, scan stages constituting the scan driving circuit can receive two scan clocks SCLK1B and SCLK2B and output scan signals. This is described with reference to FIGS. 10 and 11.

In FIG. 10, for convenience of explanation, the first scan stage SSC1(n) arranged in the n-th horizontal line among the first scan stages SSC1 forming the first scan driving circuit, which generates the first scan signals SC1, is illustrated as an example.

Meanwhile, the fourth scan driving circuit, which generates the fourth scan signals, can be configured and driven similarly to the first scan driving circuit.

The first scan driving circuit can include a plurality of first scan stages SSC1 that respectively output the first scan signals SC1 to a plurality of first scan lines arranged in the display region.

Similar to the first exemplary implementation, in the first scan stage SSC1, the output portion OC can include a pull-up transistor (or Q transistor) Ts1, a pull-down transistor (or QB transistor) Ts2, a Q capacitor CQ, and a QB capacitor CQB.

Meanwhile, as another example, similar to the second exemplary implementation, the QB capacitor CQB can be removed from the first scan stage SSC1.

Similar to the first and second exemplary implementations, the control portion CCP can include a transfer transistor TA and a plurality of control transistors Ts3, Ts4, Ts5 and Ts6. The plurality of control transistors Ts3, Ts4, Ts5 and Ts6 can include, for example, first, second, third, and fourth control transistors (or eighth, ninth, tenth, and eleventh transistors) Ts3, Ts4, Ts5, Ts6.

The N-type pull-up transistor Ts1 can have, for example, a second electrode (or drain electrode) that receives a corresponding scan clock SCLKB2 and a first electrode (or source electrode) that is connected to the output terminal NO of the first scan stage SSC1(n) . Here, the scan clock SCLKB2 input to the pull-up transistor Ts1 can be referred to as a second B scan clock SCLKB2.

At this time, the second B scan clock SCLKB2 can be a clock signal having a waveform that is opposite in phase to a first B scan clock SCLKB1.

The first control transistor Ts3 can provide the previous first scan signal SC1(n−1) , which is an output signal of the previous first scan stage SSC1, to the Q2 node in response to the corresponding scan clock SCLKB1. Here, the scan clock SCLKB1 input to the first control transistor Ts3 can be referred to as the first B scan clock SCLKB1.

The second control transistor Ts4 can be connected in parallel with the first control transistor Ts3 and can provide the previous first scan signal SC1(n−1) , which is the output signal of the previous first scan stage SSC1, to the Q2 node in response to its corresponding scan clock SCLKB2 which is the second B scan clock SCLKB2.

At this time, the first B scan clock SCLKB1 and the second B scan clock SCLKB2, which have opposite phases, can have the same pulse widths in their high and low sections. Accordingly, unlike the first and second exemplary implementations, the high sections (or low sections) of the first B and second B scan clocks SCLKB1 and SCLKB2 can be generated alternately and continuously without a substantial time interval. As an example, the low section (or high section) of the second B scan clock SCLKB2 can be positioned corresponding to (or matching) the high section (or low section) of the first B scan clock SCLKB1.

Unlike the first and second exemplary implementations, the first scan stage SSC1(n) configured as above can shift the first scan signal SC1(n−1) according to the two scan clocks SCLKB1 and SCLKB2 input thereto and output its first scan signal SC1(n) to the corresponding first scan line.

As such, the first scan stage SSC1(n) of the n-th horizontal line can operate by receiving the first B scan clock SCLKB1 and the second B scan clock SCLKB2.

Meanwhile, positions of the first B scan clock SCLKB1 and the second B scan clock SCLKB2 input to the first scan stage SSC1 located on the n−1-th and n+1-th horizontal lines, which are preceding and following the n-th horizontal line, can be opposite to positions of the scan clocks SCLKB1 and SCLKB2 input to the first scan stage SSC1(n) on the n-th horizontal line. For example, in each of the first scan stages SSC1 located on the n−1-th and n+1-th horizontal lines, the pull-up transistor Ts1 can be configured to receive the first B scan clock (SCLKB1), and the first and second control transistors Ts3 and Ts4 can be configured to receive the second B scan clock SCLKB2 and the first B scan clock SCLK1B, respectively.

The output operation of the first scan signal SC1(n) in the n-th first scan stage SSC1(n) can be described with further reference to FIG. 11.

As mentioned above, the n-th first scan stage SSC1(n) can receive the corresponding two scan clocks, the first B and second B scan clocks SCLKB1 and SCLK2, and output the corresponding first scan signal SC1(n) .

For example, during a first period t1, the previous first scan signal SC1(n−1) can be in a low state. Within the first period t1, the second B scan clock SCLK2B can transition from a low state to a high state, and conversely, the first B scan clock SCLKB1 can transition from a high state to a low state.

In this case, in the first period t1, the low voltage of the previous first scan signal SC1(n−1) can be transmitted to the Q2 node, setting the Q2 node to a low state.

Accordingly, during the first period t1, the Q node can have a low state and the QB node can have a high state. Thus, the low-level first scan signal SC1(n) can be applied to the first scan line of the n-th horizontal line.

Next, in the second period t2, the previous first scan signal SC1(n−1) can transition to a

high state. During the second period t2, the second B scan clock SCLK2B can be in a low state, and conversely, the first B scan clock SCLKB1 can be in a high state.

In this case, the first and second control transistors Ts3 and Ts4 can be turned on, so that the high voltage (i.e., gate high voltage VGH) of the previous first scan signal SC1(n−1) can be applied to the Q2 node. Accordingly, the voltage of the Q2 node can be at a high level during the second period t2.

In this case, in the second period t2, the Q node can be in a high state and the QB node can be in a low state.

Here, the second B scan clock SCLKB2 can have a low-level voltage (i.e., gate low voltage VGL) during the second period t2, so that the low-level first scan signal SC1(n) can be applied to the first scan line of the n-th horizontal line.

As above, corresponding to the high section of the previous first scan signal SC1(n−1) , the low-level section of the second B scan clock SCLK2B that controls the second control transistor Ts4 and the high-level section of the first B scan clock SCLKB1 that controls the first control transistor Ts3 can be set. As an example, the high section of the previous first scan signal SC1(n−1) can be set to substantially coincide with (or have substantially the same timing as) the low section of the second B scan clock SCLK2B and the high section of the first B scan clock SCLKB1.

Next, in the third period t3, the previous first scan signal SC1(n−1) can be switched to a low state. During the third period t3, the second B scan clock SCLK2B can have a high state, and conversely, the first B scan clock SCLKB1 can have a low state.

In this case, the first and second control transistors Ts3 and Ts4 can be turned off. Accordingly, during the third period t3, the Q2 node can be maintained in a high state, the Q node can be maintained in a high state, and the QB node can be maintained in a low state.

Here, during the third period t3, the second B scan clock SCLKB2 has a pulse of the high voltage (i.e., gate high voltage VGH), the high-level first scan signal SC1(n) can be applied to the first scan line of the n-th horizontal line.

Next, in the fourth period t4, the previous first scan signal SC1(n−1) can maintain a low state. During the fourth period t4, the second B scan clock SCLK2B can transition from a low section to a high section, and conversely, the first B scan clock SCLKB1 can transition from a high section to a low section.

In this case, similar to the first period t1, in the fourth period t4, the low voltage of the previous first scan signal SC1(n−1) can be transmitted to the Q2 node, so that the Q2 node can be set to a low state.

Accordingly, in the fourth period t4, the Q node can be in a low state and the QB node can be in a high state. Thus, the low-level first scan signal SC1(n) can be applied to the first scan line of the n-th horizontal line.

Through the above operation, the nth first scan stage SSC1(n) can stably output the first scan signal SC1(n) to the corresponding first scan line.

As described above, the first scan stage SSC1 of this exemplary implementation can operate by receiving the two scan clocks SCLKB1 and SCLKB2.

Therefore, compared to the first and second exemplary implementations, a number of scan clocks in this exemplary implementation can be reduced, and the first scan driving circuit can be designed more simply and with a smaller size.

Therefore, the size of the gate driving circuit can be further reduced, thereby further reducing the width of the bezel, thereby enabling a narrow bezel.

As described above, in the exemplary implementations of the present disclosure, the scan driving circuit of the gate driving portion, which generates the scan signal applied to the transistor configured with an oxide semiconductor disposed in the pixel, can include the transistors configured with an oxide semiconductor and can receive a plurality of clock signals and output the scan signal.

As such, the scan driving circuit can generate the scan signal using the scan clocks and the transistors configured with an oxide semiconductor, without a separate inverter circuit configured of an CMOS. Although the above exemplary implementations are described based on that the N-type transistors are configured with an oxide semiconductor, and that the P-type transistors are configured with a polycrystalline silicon layer, implementations are not limited thereto. As an example, the N-type transistors can be configured with a polycrystalline silicon layer or other semiconductors and/or the P-type transistors can be configured with an oxide semiconductor or other semiconductors, without being limited thereto.

Accordingly, a number of transistors in the scan driving circuit can be reduced, and thus the scan driving circuit can be designed to be simple and have a small size (or area). Thus, the size of the gate driving portion can be reduced, thereby reducing the width of the bezel of the display apparatus, enabling a narrow bezel of the display apparatus.

Furthermore, since a number of transistors can be reduced, a power required to drive the reduced number of transistors can be reduced, thereby resulting power consumption and enabling lower-power operation.

Furthermore, the QB capacitor can be eliminated from the scan driving circuit, and thus the scan driving circuit can be designed more simply and with a smaller size. Therefore, the size of the gate driving portion can be further reduced, thereby further reducing the width of the bezel, thereby enabling a narrow bezel.

Furthermore, a number of scan clocks input to the scan driving circuit can be reduced, and thus the scan driving circuit can be designed more simply and with a smaller size. Therefore, the size of the gate driving portion can be further reduced, thereby further reducing the width of the bezel, thereby enabling a narrow bezel.

It will be apparent to those skilled in the art that various modifications and variation can be made in the present disclosure without departing from the spirit or scope of the disclosure.

Thus, it is intended that the present disclosure cover the modifications and variations of this disclosure provided they come within the scope of the appended claims and their equivalents.

What is claimed is:

1. A display apparatus, comprising:
a display panel including a pixel, wherein the pixel includes a light emitting diode and a plurality of transistors configured to be electrically connected to the light emitting diode; and
a first scan driving circuit including, for each of a plurality of horizontal lines of the display panel, a first scan stage that is configured to output a first scan signal of the horizontal line,
wherein the first scan stage includes:
a pull-up transistor and a pull-down transistor, wherein a gate electrode of the pull-up transistor is connected to a first node and a gate electrode of the pull-down transistor is connected to a second node;
a transfer transistor connected between the first node and a third node;
a first control transistor and a second control transistor which are connected in parallel to each other, have a first electrode configured to receive a carry signal, and have a second electrode connected to the third node; and
a third control transistor and a fourth control transistor which are connected in series to each other with the second node therebetween, and have respective gate electrodes connected to the third node,
wherein the first scan stage that is configured to output the first scan signal of a n-th horizontal line is configured to apply the first scan signal of the n-th horizontal line to a first transistor among the plurality of transistors, and
wherein in the first scan stage that is configured to output the first scan signal of the n-th horizontal line, a gate electrode of the first control transistor is configured to receive a first scan clock, a drain electrode of the pull-up transistor is configured to receive a second scan clock, and a gate electrode of the second control transistor is configured to receive a third scan clock or the second scan clock.

2. The display apparatus of claim 1, wherein the pull-up and pull-down transistors, the first and fourth control transistors, and the transfer transistor include oxide semiconductors.

3. The display apparatus of claim 2, wherein the first transistor among the plurality of transistors includes an oxide semiconductor.

4. The display apparatus of claim 1, wherein the pull-up and pull-down transistors, the first and fourth control transistors, the transfer transistor, and the first transistor among the plurality of transistors are N-type transistors.

5. The display apparatus of claim 4, wherein a gate electrode of the transfer transistor is configured to receive a gate high voltage, a first electrode of the third control transistor is configured to receive the gate high voltage, and a first electrode of the fourth control transistor and a source electrode of the pull-down transistor are configured to receive a gate low voltage.

6. The display apparatus of claim 1, further comprising a first capacitor connected between the first node and a source electrode of the pull-up transistor.

7. The display apparatus of claim 1, further comprising a second capacitor connected between the second node and a source electrode of the pull-down transistor.

8. The display apparatus of claim 1, wherein, in the first scan stage that is configured to output the first scan signal of the n-th horizontal line, the gate electrode of the second control transistor is configured to receive the third scan clock, the third scan clock and the first scan clock have opposite phases, and a high section of the first scan clock and a high section of the second scan clock are separated by a predetermined time.

9. The display apparatus of claim 8, wherein, in each of the first scan stage that is configured to output the first scan signal of a n−1-th horizontal line and the first scan stage that is configured to output the first scan signal of a n+1-th horizontal line: the drain electrode of the pull-up transistor is configured to receive the first scan clock, the gate electrode of the first control transistor is configured to receive the second scan clock, and the gate electrode of the second control transistor is configured to receive a fourth scan clock, and
wherein the fourth scan clock and the second scan clock have opposite phases.

10. The display apparatus of claim 8, wherein a low section of the second scan clock is set to a width greater than a high section of the carry signal, and
a high section of the second scan clock is set to a width less than a low section of the first scan clock.

11. The display apparatus of claim 8, wherein a high section of the carry signal is set to coincide with a low section of the third scan clock and a high section of the first scan clock.

12. The display apparatus of claim 1, wherein, in the first scan stage that is configured to output the first scan signal of the n-th horizontal line, the gate electrode of the second control transistor is configured to receive the second scan clock, the first scan clock and the second scan clock have opposite phases, and the first scan clock and the second scan clock have a same width of a high section.

13. The display apparatus of claim 12, wherein, in each of the first scan stage that is configured to output the first scan signal of a n−1-th horizontal line and the first scan stage that is configured to output the first scan signal of a n+1-th horizontal line, the drain electrode of the pull-up transistor is configured to receive the first scan clock, the gate electrode of the first control transistor is configured to receive the second scan clock, and the gate electrode of the second control transistor is configured to receive the first scan clock
14. The display apparatus of claim 12, wherein a high section of the carry signal is set to coincide with a low section of the second scan clock and the high section of the first scan clock.

15. The display apparatus of claim 2, wherein the second and third control transistors include polycrystalline silicon.

16. The display apparatus of claim 15, wherein the plurality of transistors in the pixel include a transistor including the polycrystalline silicon.

17. The display apparatus of claim 16, wherein the second and third control transistors, and the transistor including the polycrystalline silicon in the pixel are P-type transistors.

18. The display apparatus of claim 1, wherein the first transistor is configured to connect a gate electrode of a driving transistor among the plurality of transistors and a second electrode of the driving transistor in response to the first scan signal, or
the first transistor is configured to transmit an initialization voltage to the gate electrode of the driving transistor in response to the first scan signal.

19. The display apparatus of claim 1, wherein the plurality of transistors in the pixel include a second transistor including the oxide semiconductor, and
wherein the display apparatus further comprises a second scan stage that is configured to apply a second scan signal to the second transistor, wherein the second scan stage is configured with a same structure as the first scan stage that is configured to output the first scan signal of the n-th horizontal line.

20. A display panel, comprising:
a pixel including a light emitting diode and a plurality of transistors configured to electrically connected to the light emitting diode; and
a first scan driving circuit including a scan stage that is configured to output a scan signal of a horizontal line of the display panel and to apply a scan signal to a first transistor among the plurality of transistors,
wherein the scan stage includes:
a pull-up transistor and a pull-down transistor, a gate electrode of the pull-up transistor is connected to a first node and a gate electrode of the pull-down transistor is connected to a second node;
a transfer transistor connected between the first node and a third node;
a first control transistor and a second control transistor which are connected in parallel to each other, have a first electrode configured to receive a carry signal, and have a second electrode connected to the third node; and
a third control transistor and a fourth control transistor which are connected in series to each other with the second node therebetween, and have respective gate electrodes connected to the third node,
wherein a gate electrode of the first control transistor is configured to receive a first scan clock, a drain electrode of the pull-up transistor is configured to receive a second scan clock, and a gate electrode of the second control transistor is configured to receive a third scan clock or the second scan clock.
